(19) United States
(12) Patent Application Publication
(10) Pub. No.: US 2023/0003646 A1
(43) Pub. Date: Jan. 5, 2023

(54) TIME-RESOLVED METHOD OF PROTEIN ANALYSIS

(71) Applicant: UCL BUSINESS LTD., London (GB)

(72) Inventors: John HALES, London, Greater London (GB); Paul DALBY, London, Greater London (GB)

(21) Appl. No.: 17/784,836

(22) PCT Filed: Dec. 14, 2020
(86) PCT No.: PCT/EP2020/086006

§ 371 Date: Jun. 13, 2022

(30) Foreign Application Priority Data
Dec. 12, 2019 (GB) 1918336.7

(51) Int. Cl. G01N 21/64

(52) U.S. Cl. CPC G01N 21/6408; G01N 21/6486

(57) ABSTRACT

A method of quantifying the concentration of a protein of interest, or the concentration of a conformational state of the protein of interest, in a mixture, wherein the protein of interest or conformational state has an intrinsic fluorescence decay signature. The method comprises: addressing the mixture with one or more pulses of light, wherein the light has a wavelength in the 240-295 nm range, preferably in the 250-280 nm range, further preferably wherein the laser light has a wavelength of 266 nm. The method further comprises: taking a series of measurements of the fluorescence intensity of the mixture at a series of time points where the time interval between a fluorescence measurement and a preceding light pulse is recorded. The series of measurements comprises measurements for which the time intervals differ from each other by less than a nanosecond, and where the difference between largest and smallest time intervals is at least 10 nanoseconds (ns) and/or a sufficient time to detect a decay of the fluorescence intensity towards a baseline level, such that the series of measurements defines a fluorescence decay curve. The method further comprises quantifying the concentration of a protein of interest or conformational state of the protein of interest in the sample by reference to the fluorescence decay curve.

### FIELD OF THE INVENTION

The present invention relates to an apparatus and a method for use in time-resolved analysis of proteins. In particular, the invention relates to an apparatus and an analytical method for identifying and quantifying certain proteins in a mixture, for instance in a mixture of different proteins eluted from a size exclusion chromatography column, or flowing through a tube.

### BACKGROUND

The effective chromatographic separation of protein-based biopharmaceuticals from other biomolecules, based on their size, charge, hydrophobicity or binding affinity is essential at manufacturing scales, for achieving consistently high product quality. At analytical scales, it also enables detailed product quality profiling, for example to assess formulations in accelerated degradation studies, or to monitor the product during storage. During batch manufacturing, a protein is eluted from the column, and collected in fractions that are then assessed for quality prior to pooling. Chromatography was also one of the first bioprocessing steps to be amenable to continuous manufacturing, and thus also the potential to implement process analytical technology (PAT), in which the product quality is preferably continuously monitored to enable feedback control of the process parameters to achieve a consistent product profile. To achieve this, the elution profile needs to be monitored to detect changes in the product profile that result from variability in the feedstream, column reagents, or from degradation of the column itself, to ensure that the properties of the product can be maintained within defined limits.

The adoption of continuous manufacturing by the biopharmaceutical industry, for example, is a route to bringing down the cost of therapeutic drugs and encouraging investment into new drug candidates. However, the biopharmaceutical industry has lagged behind other industries in adopting continuous manufacturing, which requires sophisticated process analytical technologies to monitor key process parameters and critical product attributes, in real time. Keeping these parameters within strict bounds is important for ensuring a consistently high product quality. However, developing these analytical technologies has proven to be a major challenge.

A major barrier to implementing the PAT approach for chromatography, or on other flowing samples in a continuous manufacturing pipeline, is the availability of real-time and robust, in-line or on-line sensors, that can distinguish the product from biophysically similar proteins that tend to co-elute or co-exist with the product. Such proteins may derive from the host cell, or could be variants of the product protein including those that result from proteolysis, alternative post-translational modifications, oxidation, mis-folding, alternative conformational states, aggregation, and deamidation.

In a typical industrial bioprocess, chromatography is the key step for purifying the product from other proteins, cellular debris and components of the media. Manufacturers using chromatography in the biologics/biopharmaceuticals sector have two key ambitions, each of increasing complexity: 1) an ability to obtain more detail on the contents of the “product” elution peak, without the need for offline independent analysis; 2) an ability to make real-time measurements on the chromatography elution that reveal hidden species within a single peak, and then use this information in real-time to control the peak fractionation points (batch or continuous mode) and/or the process control parameters (in continuous mode), to optimally control the product purity and yield.

The standard technique for monitoring proteins eluted from a chromatography column is UV absorbance. While this, and related techniques, can be used for real-time measurements and process control, it is usually not possible to distinguish different proteins based on their UV absorbance alone. For instance, if two proteins co-elute, where protein 1 is a strong absorber and protein 2 is a weak absorber, and only absorbance is measured, there is no way to determine whether there is a low concentration of only protein 1, or a high concentration of only protein 2, or some mix of the two proteins giving the same total absorbance. There are numerous research groups trying to resolve this problem using sophisticated curve-fitting algorithms, and analysis of multi-wavelength absorbance spectroscopy (e.g. Hubbuch group [1], [2], [3]). However, there is limited innovation in this area in terms of new modes of detection. Consequently, manufacturers tend to “over-purify” their product with narrow peak fractionation and a resulting loss of yield, or they “under purify” by including other proteins hidden within part of their product peak. If they could make smarter fractionation and pooling decisions based on accurate quantitation of each co-eluting protein species in real time, then they would be able maximise yield and avoid over-contaminated batches, by controlling the process in real time to obtain a predefined purity of the product. For these reasons at least there is a need for an improved method of detection.

On-line UV-absorption or refractive index measurements are often used to monitor chromatography. In-batch chromatography also forms the basis for deciding which fractions to pool. However, if there are two or more overlapping peaks in the chromatogram then these techniques cannot readily be used to quantify the relative amounts of the co-eluting proteins. Therefore, off-line analytical methods such as protein gels, orthogonal analytical chromatography modes, or mass-spectrometry, are used to assess the protein purity. In a continuous manufacturing process, it is especially important to identify co-eluting contaminants to provide real-time feedback to the manufacturing process.

Co-eluting protein species can be resolved by measuring absorption spectra and analysing the data with advanced tools, such as partial least squares regression for example. However, this typically involves extensive off-line calibration and the spectral shifts between proteins are often subtle, making it difficult to resolve more than two co-eluting proteins.

Other common detection modalities, such as fluorescence intensity and electrical conductivity, are also typically univariate and therefore suffer the same drawback as UV-absorption measurements, such as the difficulty in resolving mixtures of protein species.

Mass spectrometry is a powerful tool for identifying eluted proteins, but the sample is destroyed, the analysis of the spectra is complex, and the costs of purchasing and maintaining the equipment are high.

Nuclear magnetic resonance is an effective technique for ensuring that the eluted proteins are folded into the anticipated conformation, but is relatively slow, typically limited to small proteins, and the fixed capital and variable costs are very high.

Thus, the practical usefulness of the aforementioned techniques for on-line monitoring of proteins in production processes is severely limited.

Time-resolved intrinsic fluorescence (hereafter referred to as TRF or TRIF) is a well-established spectroscopic technique that can identify proteins based on the time profile of their intrinsic fluorescence. This is dependent on the number, location and microenvironment of their aromatic residues, and is widely applicable since only 1% of proteins do not contain any aromatic residues (i.e., neither a tryptophan nor tyrosine).

Time-correlated single photon counting (TCSPC) is the most common technique for measuring fluorescence decay times. However, unless analysing very dilute solutions, TCSPC is susceptible to the “pile-up” problem, which makes it poorly suited to simultaneously measuring the fluctuations in the fluorescence intensity. In this technique, a clock starts when a pulse of excitation light is emitted in the direction of the sample and the clock stops when a photon of fluorescent light is registered by detection electronics. The time difference between the clock starting and stopping is measured many thousands or even millions of times and the resulting set of data can be analysed to work out the fluorescence lifetime. The weakness of the technique is that the clock stops when it detects the first photon to arrive at the detector, which statistically biases the measurement towards shorter time decays. If the fluorescence is too intense, then the distribution of counted photons becomes statistically biased towards shorter times, undermining the accuracy of the decay time measurement, and also its ability to resolve multiple decay components. In order to circumvent this problem, the intensity of the light reaching the detector must be reduced so that on most occasions no light is detected at all. In this low-intensity-light situation, when a photon of light is detected the probability of a second photon of light arriving at the detector is low so the statistical bias is not significant. However, operating at low levels of light is an unacceptable trade-off if the intensity must also be measured since the error of the intensity measurement would be increased and dynamic range of the measurement would be limited. Typically, this is not an issue contemplated by researchers using TCSPC in a lab setting because they are only interested in measuring the fluorescence lifetime and are not interested in also monitoring fluorescence intensity. For bioprocess monitoring it would be necessary to track the total protein content by the fluorescence intensity, while simultaneously identifying proteins in the mixture using their decay times.

Fluorescence occurs when a sample absorbs light of a specific wavelength and emits light at a different wavelength. In most cases, such as with proteins, the emitted light wavelength is longer than the absorbed light. It is known in the art that intrinsic fluorescence of the proteins is attributed from the weak fluorescence from aromatic residues, such as tryptophan and tyrosine in response to excitation with UV light (typically in the 250 nm to 290 nm wavelength region). Labelling of proteins with extrinsic fluorescent dyes provides more sensitivity, but is not considered for manufacturing as the product cannot be used as a human therapy if modified in this way.

Moreover, intrinsic fluorescence of proteins has been well-studied by measuring i) fluorescence intensity, ii) time-resolved fluorescence (TRF) lifetimes, iii) anisotropy, iv) fluorescence correlation spectroscopy etc. However, with the exception of simple fluorescence intensity measurements, the use of these techniques for chromatography monitoring has been limited, in particular for proteins.

As such, there is a need for a method that chromatographically monitors the intrinsic fluorescence of proteins whilst also satisfying all of the following criteria:
(a) The method is able to detect and quantify multiple proteins within the same sample, or within the same chromatography peak, where the shape of the peak does not necessarily reveal their presence.
(b) The method provides a fast data acquisition and analysis time, as the minimum resolution required for practical analytical or preparative chromatography of proteins is in the region of 1-10 seconds.
(c) The method is adequately sensitive, as the samples must be detectable above the background buffer signal and also the background noise, at minimum concentrations practical for analytical or preparative chromatography (e.g. sensitive at a protein concentration range of 0.01 mg/ml to 1 mg/ml).
(d) The method provides a dynamic range, as the samples must be detectable with a signal that is linearly proportional to quantity of sample in the peak, from the minimum to the maximum concentrations desired for analytical or preparative chromatography (e.g. at a protein concentration range of 0.01 mg/ml to 500 mg/ml).
(e) The method is cost-effective, as the detector should ideally use components that make the detection method of comparable cost to other detectors in use for chromatography monitoring.

A known problem in the art is that existing fluorescence intensity measurement techniques do not meet the above-mentioned criterion (a) at least. Fluorescence intensity measurements are available for chromatography, including at wavelengths suitable for protein intrinsic fluorescence intensity measurements. However, simple fluorescence intensity measurements cannot resolve the relative contributions to the signal from multiple proteins, and so cannot distinguish the presence of multiple proteins within the same sample or elution peak. Two-dimensional (2D) fluorescence intensity spectroscopy has been described for bioprocess monitoring, which scans emission spectra across a range of excitation wavelengths. While this method may be useful for identifying the presence of very different biological fluorophores (e.g. cofactors versus proteins), it is not able to resolve multiple proteins which have essentially the same 2D fluorescence spectra.

Other known problems in the art are that existing anisotropy and fluorescence correlation spectroscopy methods do not meet the above-mentioned criteria (b) to (d). Furthermore, existing fluorescence lifetime measurement methods, such as TRF or TCSPC, do not meet the criteria set out in criteria (b) to (d), and this becomes particularly acute when considering criterion (e).

The present invention has been devised in light of the above considerations.

### SUMMARY OF THE INVENTION

In realising the inventions of the present application, the inventors have developed a method and apparatus for continuously monitoring of protein species in a flowing sample, or as they are eluted from a chromatographic column even when they fully co-elute with other protein species and without making any assumption about the elution profile. To achieve this, the inventors designed and constructed a TRIF lifetime chromatograph and established an analytical framework for deconvolving and quantifying distinct but co-eluting protein species. This technology has immediate relevance as a process analytical technology for continuous bioprocessing.

According to one aspect of the invention, there is a method of quantifying the concentration of a protein of interest, or of a concentration of a conformational state of the protein of interest, in a mixture, wherein the protein of interest or conformational state has an intrinsic fluorescence decay signature. It is the intrinsic fluorescence of the proteins that is being measured, rather than any kind of fluorescent tag or label.

The method comprises: addressing the mixture with one or more pulses of light, wherein the light has a wavelength in the 240-295 nm range, preferably in the 250-280 nm range, further preferably wherein the light has a wavelength of 266 nm.

The method further comprises: taking a series of measurements of the fluorescence intensity of the mixture at a series of time points where the time interval between a fluorescence measurement and a preceding light pulse is recorded. The series of measurements comprises measurements for which the time intervals differ from each other by less than a nanosecond, and where the difference between largest and smallest time intervals is at least 5 nanoseconds (ns) and/or a sufficient time to detect a decay of the fluorescence intensity towards a baseline level, such that the series of measurements defines a fluorescence decay curve. The method further comprises quantifying the concentration of the protein of interest or the concentration of the conformational state of the protein of interest in the sample by reference to the fluorescence decay curve.

The term fluorescence “decay signature” and “optical signature” are used interchangeably throughout this application and may refer to a unique (“signature”) optical signal that may be used to characterise a particular species of protein (e.g. a protein of interest) from other (e.g. different) proteins species contained in the same mixture. It may also be used to quantify a concentration and/or a conformational state of that protein of interest. The present invention advantageously solves multiple problems associated with known analytical apparatus, methods and data fitting routines used to monitor chromatographic eluants using TRF. Furthermore, the present invention advantageously enables real-time deconvolution of the contributions from multiple protein species. For example, the TRF approach provides an alternative technique to TCSPC that negates the “pile-up” problem and enables simultaneous measurement of fluctuations of both the time decay and the fluorescence intensity repeatedly, in the order of every few seconds, and preferably at intervals of under 5 seconds (meaning that the time period between two fluorescence decay curve measurements is less than 5 seconds). In some embodiments, the time decay and fluorescence intensity is measured at intervals of under 10 seconds (meaning that the time period between two fluorescence decay curve measurements is less than 10 seconds). In other embodiments, the time interval between fluorescence decay and intensity measurements (the time period between two fluorescence decay curve measurements) is more than 30 seconds, less than 30 seconds, less than 20 seconds, less than 15 seconds, less than 3 seconds, less than 2 seconds, about 1 second, or less than 1 second.

The present invention is applicable to protein solutions at a wide range of concentrations relevant to bioprocessing. The inventors have also developed algorithms that can fit the data concurrently with data acquisition, enabling real-time product monitoring and pooling decisions. In this way, the present invention provides an analytical tool that can quantify individual protein species in a sample, e.g. in a volume of liquid that is eluted from a column, even if the protein species fully co-elutes with another protein species, without making any assumptions about the elution profile. As such, the present invention is a method that uses fluorescence lifetime measurement that meets all of the previously mentioned criteria (i.e. criteria (a) to (e)).

In devising a method of the present invention that can quantify the concentration of a protein of interest, or of a conformational state of a protein of interest, in a mixture, the inventors had to overcome a number of technical hurdles, as summarised below:

In a mixture there are two unknowns, namely the concentration and the identity of each protein. As such, one measurement cannot uniquely determine both the concentration and identity at the same time. Therefore, a second simultaneous measurement is required to uniquely determine both unknowns. There are many known analytical methods which measure different aspects of the fluorescence. For instance, a fluorimeter can measure emission spectra, fluorescence lifetimes and fluorescence anisotropy, and techniques such as fluorescence correlation spectroscopy (FCS) are also commonly used.

In their research, the inventors found spectral measurements to be unsuitable as the spectra of different proteins are not different enough to straightforwardly deconvolve them. The inventors also found FCS and fluorescence anisotropy to also be unsuitable as these methods are less capable of differentiating between protein variants of broadly similar size and shape within a mixture. However, the inventors have found that the lifetimes of different proteins are often unambiguously different and that simultaneously measuring the intensity is effective. Taking this finding, the inventors have overcome several technical challenges to realise the method of the present invention which uses fluorescence lifetime measurements in combination with fluorescence intensity measurements.

Measuring the fluorescence lifetime is often a challenging-enough measurement given the nanosecond decay times. To illustrate, the most conventional technique for making fluorescence lifetime measurements is TCSPC, which does not provide a reliable intensity measurement due to the “pile-up” problem, as discussed herein. The most obvious strategy for making a time-resolved measurement is simply to employ a detector and detector electronics with a very high bandwidth so that the fluorescence emission could be measured with a “sufficiently-high” resolution. High-bandwidth digital oscilloscopes are known in the art and have been used to directly measure the fluorescence lifetimes of polycyclic aromatic hydrocarbon compounds (PAHs) but would not be suitable for the detection of proteins due to their shorter decay times. The inventors estimated, from theoretical calculations, that this “sufficiently-high resolution” would require an oscilloscope with greater than 1 gigahertz (GHz) or even 2 GHz bandwidth, which may be significantly costly and therefore impractical from an economic perspective (e.g. satisfies criterion (e), as previously described).

In view of the above considerations, the inventors have reduced costs by using a digitizer (i.e. a machine that converts an analog signal into a digital format) in the form of a sampling oscilloscope, which is a well-known instrument, but not commonly used in the context of the application of this invention. Advantageously, the sampling oscilloscope may for example measure the voltage after a certain period of time has elapsed from receiving the trigger signal, and that period of time increments by ˜50 to 100 picoseconds (ps) after every excitation pulse until the full lifetime has been built up over 256 or 512 pulses, for example.

The decision made by the inventors to employ a sampling oscilloscope was motivated by economic considerations at the time of the invention. Any suitable digitizer (e.g. a high-bandwidth digitizer) that is capable of accurately representing the analog signal in a digital format would be sufficient. Such a high-bandwidth digitizer might be manifested, for instance, as a high-bandwidth digital oscilloscope, a high-bandwidth analog-to-digital converter on a printed circuit board, or a high-bandwidth sampling oscilloscope. As such, as the skilled person will appreciate, the employment of a sampling oscilloscope described in this application may be replaced by using any high-bandwidth digitizer.

As noted herein, the fluorescence intensity of the mixture is measured at a series of time points and the time interval between a fluorescence measurement and a preceding light pulse may optionally be recorded. The difference between the largest and smallest time intervals will be sufficient to detect a decay of the fluorescence intensity towards a baseline level. In practice, this timespan can be determined for a particular protein of interest using the methods disclosed herein. In general, the difference between the largest and smallest time intervals will be at least 10 nanoseconds (ns). However, in some embodiments, the difference between the largest and smallest time intervals may be about 5 nanoseconds (ns), about 6 ns, about 7 ns, about 8 ns, about 9 ns, about 10 ns, about 11 ns, about 12 ns, about 13 ns, about 14 ns, about 15 ns, about 16 ns, about 17 ns, about 18 ns, about 19 ns, about 20 ns, about 25 ns, about 30 ns, about 40 ns or about 50 ns. In some embodiments, the difference between the largest and smallest time intervals may be at least 5 nanoseconds (ns), at least 6 ns, at least 7 ns, at least 8 ns, at least 9 ns, at least 10 ns, at least 11 ns, at least 12 ns, at least 13 ns, at least 14 ns, at least 15 ns, at least 16 ns, at least 17 ns, at least 18 ns, at least 19 ns, at least 20 ns, at least 25 ns, at least 30 ns, at least 40 ns or at least 50 ns. The difference between the largest and smallest time intervals may be defined as being a time selected from a range of possible times, wherein the upper and lower bounds of that range may be defined by a value listed herein.

The apparatus may comprise a beam splitter configured to split the emitted pulses of light (the excitation light) into first and second portions, where the first portion is directed to a photodiode and the second portion is directed towards the protein of interest in the mixture of proteins.

In an example embodiment, the light source (or light arrangement) may be any coherent or incoherent-light source, such as a light emitting diode (LED) for example. Preferably, the light source may be a monochromatic light source, such as a laser. The laser may output an electronic trigger, which is an electronic signal generated in response to the emission of the excitation pulse. However, there may be some variation in the time between the light pulse being emitted and the trigger being sent. This is called trigger jitter and it may decrease the accuracy of the measurements. For this reason, the inventors have advantageously devised an alternative strategy for generating the trigger. To do this, a beam splitter is placed in the path of the excitation light which partially reflects some of the light onto a photodiode, and the voltage across a load resistor in response to the light pulse is then used as the trigger for the sampling oscilloscope or a high-bandwidth digitizer.

In this way, the method can accurately build-up the fluorescence decay curve by taking each measurement following a separate light pulse (optionally 256 or 512 pulses), while maintaining data accuracy, as random errors in the time-interval recordings are minimised. Thus, the present invention provides advantages over known analytical methods which use frequency-domain measurements, which is the most common strategy employed in PAH detection. To illustrate, frequency-domain measurements require continuous-wave, instead of pulsed excitation sources, and therefore either require significantly more sensitive detectors, or require much higher excitation powers for signal recovery. Moreover, these known methods are also required to be optically and electronically isolated from the environment to eliminate DC noise sources and contributions from common electrically frequencies such as 50 Hz, and the modulation of the excitation source are required to be purely sinusoidal in order to prevent the generation of harmonics.

The quantification of the concentration of the protein of interest or of the concentration of the conformational state of the protein of interest may comprise deconvoluting the fluorescence decay curve to quantify the contribution of the intrinsic fluorescence decay signature from different proteins species or conformational states of the protein species to the fluorescence decay curve.

The inventors have developed algorithms that can fit the data concurrently with data acquisition, enabling real-time product monitoring and pooling decisions. The inventors have also developed analytical tools that can quantify individual proteins species as they are eluted from the column, even if they fully co-elute with another protein species, and without making any assumptions about the elution profile. In this way, the method of the present invention advantageously allows for a contribution (or proportion) of each protein of interest to total protein in the mixture to be calculated from the fluorescence decay curve.

The quantification of the concentration of the protein of interest or concentration of the conformational state of the protein of interest may comprise calculating the area under the deconvoluted portion of the fluorescence decay curve that corresponds to the intrinsic fluorescence decay signature of the protein of interest or of a concentration of the conformational state of the protein of interest. The deconvoluted fluorescence signal is linearly proportional to the amount of that protein in the sample and thus the relative and absolute amount of the proteins may be determined at one instance in time, with no prior knowledge as to the specific amounts the protein. Thus the method of the present invention advantageously allows the absolute quantity of the protein of interest to be estimated as the area under the curve may be proportional to the concentration. The fluorescence intensity may be calculated from determining the area under the fluorescence lifetime curve, and this correlates with the amount of protein. The identity of the proteins may be determined from the fluorescence lifetime characteristics. In short, the fluorescence lifetime data may be fitted to a model which has three parameters that are characteristic to the protein. For example, these three parameters may therefore be an optical signature for the protein.

Preferably, the mixture is a liquid comprising the protein in solution. The mixture may be a portion of an eluate from a chromatography column. The methods of the invention can be used to analyse proteins in the eluate (or wash fraction) from all types of chromatography columns, e.g. ion exchange columns, size exclusion columns, affinity columns, etc. Many important protein and peptide products are purified by chromatography, for instance antibodies and other biopharmaceuticals.

The mixture may comprise more than one protein, which each have a different intrinsic fluorescence decay signature.

The deconvoluted fluorescence signal is linearly proportional to the amount of that protein in the sample and thus the relative and absolute amount of the two proteins may be determined at one instance in time with no prior knowledge as to the specific amounts of each protein.

Advantageously, the method of the present invention can quantify proteins in a mixture and may not just be limited to chromatography.

For example, decay-associated chromatograms (DACs) may be used for this analysis. In this way, decay parameters/optical signatures of the two proteins may be already known, and each fluorescence lifetime measurement may be curve fitted by summing together two decay curves, each corresponding to the lifetime expected for one or the other of the proteins based on their respective optical signatures. The amount of each decay curve required to accurately fit a particular lifetime curve may determine how much of each protein is present at that time, and this may be plotted in the DAC.

The concentration of the protein of interest or the concentration of the conformational state of the protein of interest may be calculated multiple times, to determine a change in the concentration of the protein of interest over time and/or to determine the concentration of the protein of interest in more than one eluate fraction. For example, the fluorescence decay curve may be measured multiple times, to allow a change in the concentration of the protein of interest over time and/or to determine the concentration of the protein of interest in more than one eluate fraction to be determined.

A time period of each of the multiple calculations may be less than 10 seconds. For example, a time period between two fluorescence decay curve measurements may be less than 10 seconds (e.g. satisfies criterion (b), as previously described). Furthermore, this advantageously enables the profiling of a chromatography peak in addition to the potential of creating a feedback control. For example, the chromatography peaks may be fractionated based on meeting certain composition criteria.

In this way, the method provides a fast data acquisition and analysis time and meets the minimum resolution requirement for practical analytical or preparative chromatography of proteins. In another example embodiment, the instrument may collect a series of fluorescence lifetime measurements every 4 to 5 seconds. However, there may be a short lag time, typically less than 1 second, for the method to interpret the data and generate chromatograms.

In an example embodiment, the method may acquire a series of fluorescence lifetime measurements independently from the data analysis which happens in parallel. Therefore, there may be no time lag between one fluorescence lifetime measurement and the next due to the data analysis. Once a lifetime measurement is completed it may be added to a queue to be analysed. The data analysis may not be instantaneous so there may be a time lag between the fluorescence lifetime measurement being acquired and the completion of the data analysis.

For example, if lifetime measurements are acquired every 4 seconds, then the data analysis from the previous measurement is complete before the latest measurement arrives in the queue and so every new measurement is always at the start of the queue. However, if the time period between measurements were shortened sufficiently then the size of the queue may exceed 1 lifetime measurement. If the signal is too low to analyse, for instance if there were no protein present in the sample, then the lifetime measurement is not added to the queue. By decoupling the data acquisition and data analysis such that they can advantageously happen in parallel. In this way, the inventors have demonstrated a method of decay chromatogram (DC) analysis on-the-fly. As the skilled person will appreciate, decay-associated chromatogram (DAC) may also be possible on-the-fly. The total experiment time is not impacted by the method of data acquisition. In the context of a chromatographic separation experiment, the time taken to generate a complete chromatogram for a protein species may be determined by the column and pump configuration and the analysis time, and not the detector. For example, if it takes 1 min for a protein to elute from a column, then it takes 1 min plus any lag time to analyse the data to generate the chromatogram if measuring on-the-fly.

The concentration of more than one protein may be quantified. Thus, the method of the present invention is advantageously applicable to mixtures comprising multiple different varieties, or types, of proteins. The method is also advantageously applicable to at a wide range of protein concentrations which ensures that it may be relevant to the fields of bioprocessing or food industry research, for example.

The concentrations of the proteins may be quantified by deconvoluting more than one intrinsic fluorescence decay signature from a single fluorescence decay curve.

The method of the present invention may not be limited to analysing two protein species. For example, the optical signatures of three species of protein may be input instead of two species of protein. A lifetime measurement of an ensemble of different proteins may be acquired and the data can be fitted as though there are just one additional protein species present in the sample along with a target protein of interest. For example, the method may be able to attribute an optical signature to the cell lysate, and then generate DACs as previously described, except that one curve may be the cell lysate and the other may be the protein of interest.

The concentrations of the proteins may be quantified by deconvoluting an intrinsic fluorescence decay signature from a first mixture and an intrinsic fluorescence decay signature from a second mixture, wherein the first and the second mixtures may eluate from a column at different elution times. Alternatively, the concentrations of the proteins are quantified by deconvoluting a first intrinsic fluorescence decay signature and a second intrinsic fluorescence decay signature from a single mixture, which contains both proteins.

The light source (or light arrangement) may be any coherent or incoherent-light source, such as a light emitting diode (LED), for example a white-light LED. Preferably, the light source is a monochromatic light source, such as a laser (or laser system). The one or more pulses of light may have a pulse width which may be less than 10 ns, preferably less than 5 ns, further preferably less than 2 ns. For example, the pulse width may be preferably more than 1 ns but less than 2 ns, and more preferably approximately 1.1 ns.

Ideally, the excitation pulse needs to be as short as possible because this is a TRF measurement. However, the inventors have devised a method which advantageously provides a trade-off between the energy of the pulse, its pulse length, and the cost of the laser system. For example, using a nanosecond pulsed laser may affect the data analysis as the pulse length (e.g. in the region of ˜1 ns) may be longer than a typical first decay components (e.g. in the region of 0.4 ns to 0.9 ns), and not much shorter than a typical second decay component (e.g. in the region of 2 ns to 7 ns). Consequently, the output may be a convolution of the time profile of the excitation pulse, the fluorescence lifetime of the sample, and the instrument response of the detector electronics. This impacts the data analysis because the data then has to be fitted to a different model. It also affects the apparatus design because a mechanism for measuring the impulse response of the system has to be devised. In this way, the inventors have designed the apparatus configuration to make it possible to detect very subtle differences between the proteins. In general, the more accurately the lifetime measurements can be acquired, the more accurately the optical signatures can be initially determined, and the more accurately the amount of each protein at a given time can be calculated.

The fluorescence decay curve may be fitted to a single-exponential or double-exponential model. More than two exponentials could also be envisaged if the complexity of the sample requires it. For example, a fixed third exponential model (e.g. an exponential with a very low amplitude and a very long time decay) may be used such that it effectively acts as a dummy exponential, while two other exponential models obtain fluorescence decay curve information.

The intrinsic fluorescence decay signature of the protein of interest may be determined by addressing a sample comprising the protein of interest and essentially no other proteins with the one or more pulses of light as defined in the previous statements, and taking the series of measurements of the fluorescence intensity of the sample as defined in the previous statements.

The deconvoluton of the fluorescence decay curve may comprise statistical modelling of the fluorescence decay curve for quantifying more than two co-eluting proteins.

There may be two ways that the invention “quantifies” more than two co-eluting protein species. Firstly, if one protein species is a constant mixture of protein species (constant in the sense that the relative proportion of each constituent protein species is not changing). Secondly, if the protein species are not completely overlapping (i.e. they are partially co-eluting). For example, if three protein species elute at exactly the same time, then quantifying all three may not be possible, but if one and two overlap partially, and two and three partially overlap, and one and three do not overlap, then all three may be quantified. In this way, the inventors have developed algorithms to quantify three species when there is a higher degree of overlap. Advantageously, the method of the present invention can therefore quantify at least two co-eluting protein species as it enables simultaneous measurement of changes in both the time decay and the fluorescence intensity.

The contribution of a background noise signal, I_{background(t)}, may be calculated using the following equation:

I_{background}(t)=cθ

where c is a baseline offset value and θ is a width of the time window of a high-bandwidth digitizer or a sampling oscilloscope.

In other words, the fluorescence intensity of the background signal (or noise), I_{background (t)}, is the product of the baseline offset c and the width of the time window θ, which advantageously accounts for electrical noise of the apparatus and improves the accuracy of the measurements. The baseline offset c may be empirically determined or calculated by taking the median of a preselected number of initial data points. In preferred embodiments, the baseline offset c may be empirically determined or calculated by taking the median of the first 5 points, the first 6 points, the first 7 points, the first 8 points, the first 9 points, the first 10 points, the first 11 points, the first 12 points, the first 13 points, the first 14 points, or the first 15 points of the digital signal, which correspond to a region of time before the excitation pulse has arrived at the sample or sample capillary.

In another embodiment of the present invention, the method may further comprise a generation of one or more decay chromatograms, DCs, by fitting a double, DC-2, exponential model to the fluorescence decay curve.

In yet another embodiment of the present invention, the method may further comprise a generation of one or more decay-associated chromatograms, DACs, by fitting equation (8) to the fluorescence decay curve, and calculating the contribution of each proteins species to the fluorescence intensity measured across the time window using equation (14).

In another embodiment, the method may further comprise quantifying more than two co-eluting proteins by simultaneous measurement of both a time decay and the fluorescence intensity.

In yet another embodiment, each protein species has a characteristic τ1, τ2 and β that can be used to identify that species, where in a sum of two exponential decays model, τ1 and τ2 are the first and second fluorescence decay times and β is the contribution of the first decay component.

The invention also provides apparatus for performing the methods of the invention.

Accordingly, another aspect of the invention provides an apparatus for measuring the concentration of a protein of interest in a mixture of proteins. The apparatus comprising: a light source capable of addressing the mixture with pulses of light at a wavelength in the range 240-290 nm, preferably in the range 250-280 nm, further preferably at a wavelength of 266 nm. The apparatus further comprising one or more detectors are responsive to light at wavelengths between 300 nm and 400 nm and are configured to measure the fluorescence intensity of the mixture, where said one or more detectors are capable of taking a series of measurements, each measurement spanning a sub-nanosecond time interval, and a trigger system capable of initiating the first measurement before the signal from the fluorescence measurements arrives at a digitizer.

In this way, the trigger system may be capable of initiating measurements, where the trigger system is preferably triggered by the onset of the excitation-light pulse.

In realising the apparatus of the present invention, the inventors have constructed an experimental analytical set-up to monitor mixtures (e.g. chromatographic eluants) using TRF that enables the real-time quantification of the contributions of a protein of interest, or even the contributions of multiple protein species. The inventors have designed the optical configuration, selected the light sources, the detectors, the optical components, and have written the software to analyse the data.

In the broadest terms, the layout of the apparatus comprises the following: a sample, comprising a protein of interest in a mixture of proteins, addressed by an excitation light pulse. A fluorescence emission is collected and directed to one or more detectors via optical filters which block the excitation light, and the detector converts the light to an electrical current. The electronics converts the current to a voltage which is then recorded, and the output is analysed. To illustrate, the inventors used a light arrangement in the form of a nanosecond pulsed laser with emission in the region 250 nm to 290 nm. This advantageously generated pulses with sufficient energy for the resulting fluorescence to be measurable across the range of protein concentrations of interest (e.g. between 0.01 and 500 mg/ml). The light source may be a single light emitting diode (LED), an array of LEDs, and/or a laser. If using a laser light source, the laser is preferably a diode pumped Q-switched solid state laser.

Lasers provide a readily available source of monochromatic light. Diode pumped Q-switched solid state lasers can advantageously produce a pulsed output beam where each light pulse has an extremely high (e.g. kilowatt peak) power. Advantageously, this is a much higher power output than would be produced by the same laser if it are operating in a continuous wave (constant output) mode. In an exemplary embodiment, the diode pumped Q-switched solid state laser is a frequency quadrupled diode-pumped Nd:YAG laser used to generate light at 266 nm.

The intrinsic fluorescence decay emission may be reflected towards the one or more detectors by a reflector or a lens. In some embodiments, the fluorescence decay emission is reflected by an ellipsoidal reflector. The decay emission may be reflected via a long-pass and/or short-pass optical filter, towards the one or more detectors. Preferably, the long-pass and/or short-pass optical filters are dielectric optical filters. In this way, the decay emission passes through (and is not reflected by) the optical filters towards the one or more detectors. In an example embodiment, the optical filters may have a dielectric coating, whereas the ellipsoidal reflector may not necessarily be coated.

In devising the present invention, the inventors realised that stray light may enter the sample. For instance, when using the Q-switched frequency-quadrupled diode-pumped Nd:YAG laser to generate light at 266 nm, stray light at 532 nm and 1064 nm wavelengths was found to enter the sample. This stray light can be problematic as it makes it difficult to distinguish between signals generated by fluorescence from the sample, and by background light (e.g. light generated by the light source itself). The inventors solved this problem by introducing a filter assembly for blocking light, particularly at 266 nm, but also at 532 nm and 1064 nm wavelengths. Thus, the use of optical filters described herein prevents light from the light source from impinging on the one or more detectors. In an example embodiment, the filter assembly may be a long-pass dielectric filter. In light of this disclosure, the skilled person can perform the necessary optical and electronic calculations and select a laser accordingly.

The one or more detectors may be one or more photodiodes. In realising the present invention, the inventors found “ultrafast” photodiodes (hereafter referred to as “UF-PDs”) to be optical suitable detectors. A rise time may be the time taken by a signal to change from a specified low value to a specified high value. Throughout the present application, the term “ultrafast” is used to signify that the photodiodes have a bandwidth that is “high” and/or have a rise time that is “short”. In other words, the bandwidth of the photodiode may be “high”, or alternatively the rise time of the photodiode may be “short”, or the photodiode has both a “high” bandwidth and a “short” rise time. For example a “high” bandwidth may be a bandwidth with a GHz order of magnitude, whereas a “short” rise time may be a rise time with a nanoscale order of magnitude or lower. For example, the UF-PDs used in the present invention may have a sub-nanosecond rise time. Alternatively, or additionally, the UF-PDs may have a bandwidth in the range between 2 GHz and 12 GHz. In this way, the UF-PDs can provide a sufficiently high bandwidth and responsivity to light at wavelengths between 300 nm and 400 nm.

The one or more ultra-fast photodiodes may comprise a high bandwidth transimpedance amplifier. Preferably, the one or more ultra-fast photodiodes may be configured to provide a rise time of less than 175 ps.

In the literature, photomultipliers tubes (PMTs) are often used when the detector has been explicitly stated. In those cases where it was not stated, measurements are instead made with a stand-alone spectrometer. A drawback of PMTs are that they typically have rise times longer than 1 ns. It is a known problem in the art to try to eliminate background signals, due to the sensitivity of PMTs to low light levels. The UF-PDs used in the present application may be connected to high bandwidth transimpedance amplifiers. For example, the high bandwidth transimpedance amplifiers may provide a rise time of less than 175 ps. As such, the UF-PD advantageously do not suffer the rise time problems of PMTs. Moreover, the additional sensitivity provided by PMTs are not required since protein concentrations are relatively high in most purification procedures, and since the present invention utilises a pulsed laser light measurement.

In the course of the development of the apparatus of the present invention, the inventor's realised a conflict between wanting to increase the intensity of the laser to boost the signal detected by the detector, and the need to decrease the intensity of the light source, to reduce damage to the capillary. Advantageously, the light is focused into the flow cell to increase the intensity of the pulse within the flow cell, while avoiding damage to the flow cell itself.

As such, the inventor's also found that reflectors can enhance the sensitivity of the apparatus of the invention. For instance, an ellipsoidal reflector may be used to surround the capillary to collect as much light as possible from a solid angle and direct it towards the detector. As the skilled person will appreciate, other shaped light reflectors and lenses may also be used to direct a large proportion of the fluorescent light towards the detector.

Moreover, the laser had unexpected consequences for the design of the liquid flow system of the apparatus of the present invention. For example, the inventors found that if the laser is focused to a spot on the capillary then it etches away the glass and eventually causes the capillary to break. The inventors solved this problem by focusing the laser to a point which was not coincident with the capillary so that a larger area on the capillary is illuminated and therefore the energy per unit area is reduced. For instance, the light source may be focused either in front of or behind the capillary. In the course of development of the apparatus of the present invention, the inventors' also trialed a curved-capillary design to limit shadowing of the emission by the capillary, but this design is particularly prone to damage, and so a straight capillary is used instead.

The invention includes the combination of the aspects and preferred features described except where such a combination is clearly impermissible or expressly avoided.

### SUMMARY OF THE FIGURES

Embodiments and experiments illustrating the principles of the invention will now be discussed with reference to the accompanying figures in which:

FIG. 1 is a schematic of the apparatus according to one embodiment of the present invention.

FIG. 2a and FIG. 2b show distinct fluorescence decay curve generated for BSA and Ova respectively. Models of the atomic-resolution structures of the respective proteins are inset.

FIG. 3a, FIG. 3b, FIG. 3c, FIG. 3d and FIG. 3e show distinct fluorescence decay curves for different elution volumes for a BSA and Ova sample as eluted from a SEC column.

FIG. 4a shows a total fluorescence chromatogram (TFC) showing the variation in the total fluorescence intensity, as calculated from the area under each decay curve, as a function of the elution volume. FIG. 4b illustrates the decay chromatogram using a single decay-component model (DC-1). FIG. 4c, 4d, 4e illustrate the first and second decay components (τ₁ and τ₁) and the first-decay component contribution (β) for the decay chromatogram using a double decay-component model (DC-2). FIG. 4f shows a decay-associated chromatogram (DAC) showing a variation in the total fluorescence intensity associated with each individual protein species.

FIG. 5a, FIG. 5b, and FIG. 5c show real-time TRIF lifetime chromatographs of BSA and Ova separated from the SEC column in one experiment. FIG. 5a is the total fluorescence chromatogram (TFC), FIG. 5b is the first decay component τ₁ and FIG. 5c is the second decay component τ₂. The data in FIG. 5a is the same as in FIG. 4a. The data fitted to generate FIGS. 5b and 5c is the same as for FIGS. 4c and 4d, but for FIG. 4 the data fitting was performed retrospectively.

FIG. 6 illustrates a sequence of chromatograms, including the (a) TFC, (b) DC-1, (c) TAU1, (d) TAU2, (e) FDCC, and (f) DAC for each of the experiments;

FIG. 7 illustrates TFCs of the (a) first and (b) second experiment, and the DACs (c) and (d) traces for BSA and Ova respectively.

FIG. 8 illustrates that the peak areas in a DAC can be used to quantify protein concentration. The area under each of the primary peaks for the DAC traces for BSA and Ova in FIG. 7 have been plotted against the known concentration and there are linear fits to each of the scatter plots.

### DETAILED DESCRIPTION OF THE INVENTION

Aspects and embodiments of the present invention will now be discussed with reference to the accompanying figures. Further aspects and embodiments will be apparent to those skilled in the art. All documents mentioned in this text are incorporated herein by reference.

The features disclosed in the foregoing description, or in the following claims, or in the accompanying drawings, expressed in their specific forms or in terms of a means for performing the disclosed function, or a method or process for obtaining the disclosed results, as appropriate, may, separately, or in any combination of such features, be utilised for realising the invention in diverse forms thereof.

While the invention has been described in conjunction with the exemplary embodiments described above, many equivalent modifications and variations will be apparent to those skilled in the art when given this disclosure. Accordingly, the exemplary embodiments of the invention set forth above are considered to be illustrative and not limiting. Various changes to the described embodiments may be made without departing from the spirit and scope of the invention.

For the avoidance of any doubt, any theoretical explanations provided herein are provided for the purposes of improving the understanding of a reader. The inventors do not wish to be bound by any of these theoretical explanations.

Any section headings used herein are for organizational purposes only and are not to be construed as limiting the subject matter described.

Throughout this specification, including the claims which follow, unless the context requires otherwise, the word “comprise” and “include”, and variations such as “comprises”, “comprising”, and “including” will be understood to imply the inclusion of a stated integer or step or group of integers or steps but not the exclusion of any other integer or step or group of integers or steps.

It must be noted that, as used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by the use of the antecedent “about,” it will be understood that the particular value forms another embodiment. The term “about” in relation to a numerical value is optional and means for example +/−10%.

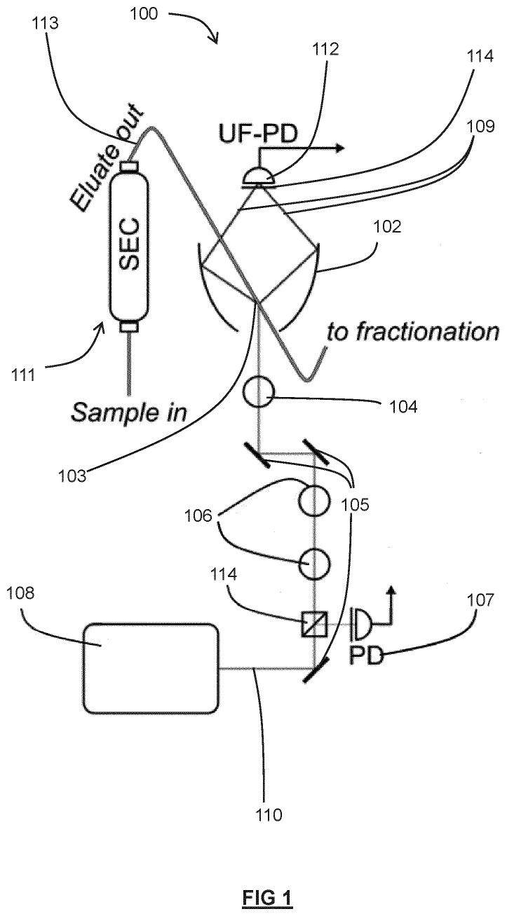

FIG. 1 is a schematic of the apparatus 100 according to one aspect of the invention.

The apparatus 100 is able to measure the concentration of a protein of interest in a mixture of proteins. In this way, the apparatus 100 forms a TRIF chromatograph comprising a liquid flow, optical, electronic, and signal processing sub-assemblies, as detailed below.

Referring to FIG. 1, the apparatus 100 comprises: a light arrangement 108 capable of emitting pulses 110 of light at a wavelength in the range 240-290 nm. In a preferred embodiment, the light arrangement 108 is capable of emitting pulses 110 of light at a wavelength in the range in the range 250-280 nm. In another preferred embodiment, the light arrangement 108 is capable of emitting pulses 110 of light at a wavelength of 266 nm. The one or more detectors 112 are responsive to light at wavelengths between 300 nm and 400 nm and are configured to measure the fluorescence intensity of the sample of interest 103. The one or more detectors 112 are capable of taking a series of measurements, each measurement spanning a sub-nanosecond time interval. The apparatus 100 further comprises a trigger system capable of initiating the first measurement before the signal from the fluorescence measurements arrives at the digitizer.

The apparatus 100 may comprise a sample 103 of interest, comprising a protein of interest in a mixture of proteins, addressed by an excitation light produced by the light arrangement 108.

The labelled line indicates a light path 110 as travelled and directed by beam shaping optics of the apparatus 100 arrangement of the present invention. In other words, the light path 110 indicates a light beam path of the excitation light directed towards the sample 103 of interest. The light paths 109 indicate two example trajectories taken by the fluorescent light emitted by the sample 103 of interest after the sample 103 has been addressed by an excitation light 110.

As shown in FIG. 1, the beam shaping optics may comprise the following optical components: a beam splitter 114, beam shaping lenses 106, beam steering mirrors 105, and a focusing lens 104. FIG. 1 illustrates an example trajectory of excitation light 110 in the apparatus 100, which is as follows: i) the excitation light 110 is emitted by the light arrangement 108, ii) the excitation light 110 is reflected by a first beam steering mirror 105 towards a beam splitter 114, iii) the beam splitter 114 splits a first portion of the excitation light 110 off towards a photodiode 107, and iv) the remaining (second) portion of the excitation light 110 traverses two beam shaping lenses 106, and is v) directed by a second and third beam steering mirrors 105, towards the focusing lens 104, vi) the focusing lens 104 focusses the remaining portion of the excitation light 110 onto the sample 103 of interest. As the skilled person will appreciate, the apparatus 100 may comprise variations of the optical configuration shown in FIG. 1. For example, the previously described beam shaping optics may comprise a variation in the type, number, or order of the optical components used.

In this embodiment, the light arrangement 108 outputs an electronic trigger, which is an electronic signal generated in response to the emission of the excitation light pulse 110. However, there may be some variation in the time between the excitation light 110 (or excitation light pulse 110) being emitted and the trigger being sent. This is called trigger jitter and it may decrease the accuracy of the measurements. For this reason, the inventors have devised an alternative strategy for generating the trigger. To do this, the beam splitter 114 is placed in the path of the excitation light 110 which partially reflects some of the light onto the photodiode 107, and the voltage across a load resistor in response to the excitation light pulse 110 may then be used as the trigger for the sampling oscilloscope or the high-bandwidth digitizer. In other words, the apparatus comprises a beam splitter 114 configured to split the emitted pulses of laser light (or the excitation light 110) into first and second portions, where the first portion is directed to a photodiode and the second portion is directed towards the protein of interest in the mixture of proteins.

Light paths 109 represents the intrinsic fluorescence emission signal as emitted by the protein of interest and other proteins in the mixture of proteins due to the excitation of the aromatic residues belonging to those proteins. The sample 103 of interest is preferably a protein of interest in a mixture of proteins, such as that eluted from a size-exclusion chromatography (SEC) column 111. For example, the SEC column 111 shown in FIG. 1 is connected to a capillary 113, via tubing (not shown in the Figures), through which the eluate is flowed. In this way, the proteins flow from the SEC column 111, through the tubing, and into the capillary 113. In a preferred embodiment, the SEC column 111 is a fast protein liquid chromatography (FPLC) column connected to a FPLC pump, and the capillary is a polymer coated UV-fused silica capillary. A FPLC column is used in instead of a high performance liquid chromatography (HPLC) column. HPLC columns are used extensively in the art, but are often not appropriate for protein purification because the high pressures and solvents required cause proteins to irreversibly denature. The inventors chose FPLC over HPLC as FPLC is more appropriate for manufacturing of proteins, but as the skilled person will appreciate, HPLC and other modes of liquid chromatography could be used instead of FPLC. Advantageously, by using the SEC column 111 the elution times correlate appropriately with the hydrodynamic volume of the proteins.

A time interval between the fluorescence measurement and the preceding input trigger plus a fixed time may optionally be recorded. The time interval between the preceding light pulse and the input trigger may be fixed (or is a constant) for each measurement.

To illustrate an example operation of the previously described embodiment; the light arrangement 108 (e.g. a laser) emits a pulse of light 110. The beam splitter 114 directs some of this pulse of light 110 to the photodiode 107. A cable length running from the photodiode 107 to the sampling oscilloscope has a constant length, and the distance between the laser 108 and the photodiode 107 is constant. As such, the time between the pulse 110 being emitted from the laser 108 and the input trigger arriving at the sampling oscilloscope is also constant. Once the input trigger arrives at the sampling oscilloscope it may start taking measurements. In this way, the apparatus optionally comprises a trigger system capable of initiating measurements, where the trigger system is preferably triggered by the onset of the excitation-light pulse. For example, if the trigger system takes longer to trigger the sampling oscilloscope than the time taken for the fluorescence signal to arrive at the sampling oscilloscope, then the cable between the photodiode 107 and the sampling oscilloscope may simply be shortened to compensate for this time difference. If the time taken for the trigger system to trigger the sampling oscilloscope is much shorter than the time taken for the fluorescence signal to arrive at the sampling oscilloscope, then the cable between the photodiode 107 and the sampling oscilloscope may simply be lengthened to compensate for this time difference.

Alternatively, the sampling oscilloscope may not be required to start measuring immediately, and may instead operate after a time delay (e.g. via programming the oscilloscope's operational software) so that it is configured to “wait” for the sample's fluorescence signal 109 to arrive at the sampling oscilloscope. As such, the “start time” is initiated before the fluorescence signal 109 has arrived at the sampling oscilloscope and is the same constant time after the laser pulse 110 is emitted from the laser 108. In this way, data files may record the time since the “start time” which is the relevant time quantity. As such, there may be no requirement for the apparatus to measure the time between the preceding light pulse 110 and the “start time”. Advantageously, this avoids the length of the cables between the photodiode 107 and the sampling oscilloscope being a critical parameter in the apparatus.

In an optional embodiment, the capillary 113 may be initially optically covered by a polymer coating which prevents any incident light reaching the sample 103 of interest in order to avoid a fluorescence emission being induced, and escaping from the sample 103, prematurely. The sample 103 of interest may subsequently be exposed in a controlled way by removing (e.g. melting an area) of the polymer coating on the capillary 113 with a flame to create an optical window, for example. In this way, the incident excitation light 110 is subsequently exposed to the proteins eluted into the capillary 113 from the SEC column 111 which then induces the intrinsic fluorescence emission 109 in a controlled way. One advantage of this embodiment is that scattered excitation light cannot be reflected to another point along the material through which the liquid is being flowed and optically excite the proteins. This is advantageous because, if that were to happen, it can make the data analysis more complicated and it might also lead to photobleaching or quenching of the sample 103.

An optical reflector 102 is positioned around the sample 103 of interest in order to collect and direct (e.g. by optical reflection) the emission 109 of the sample 103 towards one or more detectors 112 of the apparatus 100. In the embodiment shown in FIG. 1, an ellipsoidal reflector 102 (as produced by Newport™) is used, however as the skilled person will appreciate, other shaped reflectors or mirrors or lenses may also be possible. The one or more detectors 112 then converts the detected light of the emission 109 into an electrical current and/or voltage output signal which is then recorded and analysed.

In the embodiment shown in FIG. 1, the one or more detectors 112 may comprise one or more ultra-fast photodiodes (UF-PDs). In this way, the ellipsoidal reflector 102 reflects the fluorescence emission 109 towards the one or more UF-PDs 112 connected to an electronic sub-assembly (not labelled in FIG. 1). The inventors used an ellipsoidal reflector 102 to collect as much emitted light as possible. This is advantageous as the UF-PDs 112 are less responsive to light than a PMT and no additional shielding from environmental light is required. As the skilled person will appreciate, there are numerous options for achieving the same goal though, for instance 4π techniques or even confocal optics with a UV-fused silica objective.

In realising the apparatus 100 of the present invention, the inventors have constructed an experimental analytical set-up to monitor chromatographic eluants using TRF that enables the real-time quantification of the contributions from multiple protein species to the fluorescence decay measurement. The inventors have designed the optical configuration, selected the light sources, the detectors, the optical components, and have written the software to analyse the data. In the broadest terms, the layout of the apparatus 100 comprises the following: a sample 103, comprising a protein of interest in a mixture of proteins, addressed by an excitation light 110. To illustrate, the inventors used a light arrangement 108 in the form of a nanosecond pulsed laser with emission in the region 250 nm to 290 nm. This advantageously generated excitation light pulses 110 with sufficient energy for the resulting fluorescence to be measurable across the range of protein concentrations of interest (e.g. between 0.01 and 500 mg/ml).

In a preferred embodiment of the present invention, the light source 108 is a diode pumped Q-switched solid state laser 108. For example, the laser 108 may be a solid-state laser system (as produced by CryLaS™) that produces pulsed laser light 110, as indicated by the excitation light 110 shown in FIG. 1. In this way, the laser 108 produces excitation light 110 in the form of excitation pulses with a certain pulse width at a wavelength of 266 nm. The laser pulse width may be less than 10 ns, preferably less than 5 ns, further preferably less than 2 ns. For example, the laser pulse width may be preferably more than 1 ns but less than 2 ns, and more preferably approximately 1.1 ns.

The excitation light 110 may be focused, via the focusing lens 104, on to an optical transparent window (not shown in the figures) located on the capillary 113. In an example embodiment, the optical transparent window may be a capillary with a 360 μm bore. Preferably the pulse energy of each pulse of the excitation light 110 is 55 microjoules (μJ) and has a repetition rate is 70 Hz. As the skilled person will appreciate, these parameter values may vary, and were chosen for optimisation reasons. For example, 55 μJ is chosen as it is the maximum pulse energy of the laser 108 used. Through trial and error, the inventors found that a frequency of 70 Hz to be a good repetition rate for maintaining laser stability of the laser 108. In future manifestations, much higher repetition rates, and possibly lower excitation pulse energies, may be used. Advantageously, a higher repetition rate may allow for more measurements to be taken, whereas using lower pulse energies may be less damaging to the optics and capillary. As the skilled person will further appreciate, there may be some pulse-to-pulse variability in the excitation energy and period of the laser 108.

Diode pumped Q-switched solid state lasers can advantageously produce a pulsed output beam of excitation light 110, where each light excitation pulse 110 has an extremely high peak power (e.g. a kilowatt peak power, 50 μJ/1 ns=50 kW). Advantageously, this is a much higher power output than would be produced by the same laser if it are operating in a continuous wave (constant output) mode. In an example embodiment, the diode pumped Q-switched solid state laser is a frequency quadrupled diode-pumped neodymium-doped yttrium aluminium garnet (Nd:Y₃Al₅O₁₂) or ‘Nd:YAG’ laser that generates light at 266 nm.

In a preferred embodiment, the emission 109 passes through a filter assembly 114 before it reaches one or more UF-PDs 112 of the apparatus 100. Since the filter assembly 114 is positioned before (e.g. in front of) the one or more UF-PDs 112, they block any excitation light 110 from entering the one or more UF-PDs 112. In devising the present invention, the inventors realised that stray light may enter the sample, particular at 532 nm and 1064 nm wavelengths. This stray light can be problematic as it makes it difficult to distinguish between signal generated by fluorescence from the sample and by background light (e.g. light generated by the light source itself). The inventors solved this problem by introducing a filter assembly for blocking light, particularly at 266 nm, but also at 532 nm and 1064 nm wavelengths. This advantageously prevented light from the laser impinging on the one or more detectors. In an example embodiment, the filter assembly 114 comprising the long-pass and/or short-pass filters, as previously described. Alternatively, or additionally, the filter assembly 114 may comprise a band-pass dielectric filter. In this way, the inventors performed the necessary optical and electronic calculations and selected a laser accordingly. In addition, considerable trial and error went into focusing the laser onto the flow cell to increase the intensity of the pulse within the flow cell, while avoiding damage to the flow cell itself.

In an example embodiment, the filter assembly 114 may be a long-pass and a short-pass dielectric filter (as produced by Semrock™). In this way, the intrinsic fluorescence decay emission may be reflected by an ellipsoidal reflector 102, via the filter assembly 114, and towards the one or more UF-PDs 112. Alternatively, the filter assembly 114 may be a neutral density filter (as produced by Thorlabs™) that enables enough light to impinge the one or more UF-PDs 112 for the excitation to be detectable so that the pulse width of the excitation can be accurately measured using the same detector electronics.

In the literature, photomultipliers tubes (PMTs) are often used when the detector has been explicitly stated. In those cases where it was not stated, measurements are instead made with a stand-alone spectrometer. A drawback of PMTs are that they typically have rise times longer than 1 ns. It is a known problem in the art to try eliminate background signals, due to the sensitivity of PMTs to low light levels. The one or more UF-PDs 112 used in the present application may be connected to high bandwidth transimpedance amplifiers (not shown in the figures). For example, the high bandwidth transimpedance amplifiers may be configured to provide a rise time of less than 175 ps. As such, the UF-PD advantageously do not suffer the slow rise time problems of PMTs. Moreover, the additional sensitivity provided by PMTs is not required since protein concentrations are relatively high in most purification procedures, and since the present invention utilises a pulsed laser light measurement. In an example embodiment, the current output from the one or more UF-PDs 112 is amplified by a 2.2 GHz transimpedance amplifier in order to generate a voltage for digitization by a 12 GHz sampling oscilloscope (as produced by Pico Technology™).

In realising the present invention, the inventors selected UF-PDs 112 with a sufficiently high bandwidth and responsivity to light at wavelengths between 300 nm and 400 nm.

The inventors also realised that there is some stray light at 532 nm and 1064 nm. This may have been problematic as it makes it difficult to distinguish signal generated by the fluorescence and signal generated by the background light from the laser. The inventors solved this problem by introducing a filter assembly 114 so that the apparatus not only blocked the 266 nm light but also the 532 nm and 1064 nm light from the laser from impinging on the ultra-fast photodiode. In this way, the inventors performed the necessary optical and electronic calculations and selected a laser accordingly. In addition, considerable trial and error went into focusing the laser onto the flow cell to increase the intensity of the pulse within the flow cell, while avoiding damage to the flow cell itself.

In a preferred embodiment, the sampling oscilloscope has a 16 bit ADC resolution and measures sub-nanosecond (<200 ps) time intervals when triggered at times corresponding to when the excitation pulse 110 is emitted. This allows the method of the present invention to advantageously remove background noise compared to a continuous-wave system, where 1 s of background is measured every second.

The sampling oscilloscope may optionally have a time resolution of 120 ps and voltage resolution of 16 bit from 256 excitation pulses in less than 5 seconds. The maximum and minimum voltage may be adjusted between lifetime measurements to maximise the voltage resolution without saturating the digitizer. Preferably, a voltage range of the digitizer (e.g. a sampling oscilloscope) may be scalable in order to modulate, or adjust, the detection sensitivity to signal strength (e.g. in accordance with different protein concentrations). The scaling of the voltage range is done such that the signal advantageously fills the digitizer without exceeding the maximum or minimum voltages, but the intensity of signal changes between measurements. In an example embodiment, an operational software of the invention may comprise two ‘layers’ of software that work together; an operational software of the sampling oscilloscope and another software program (written by the inventors). The operational software of the sampling oscilloscope may be responsible for sending commands that result in the voltage range being adjusted. The other software program (written by the inventors) works out what the voltage range should be, and then communicates this with the operational software of the sampling oscilloscope in order to initiate the appropriate voltage range adjustments. For example, the operational software of the sampling oscilloscope may be configured to adjust the voltage range before each measurement begins, so that the voltage range is suitable for the upcoming measurement. To illustrate a working example, if the peak of the signal is at 0.07 V, then it is undesirable to set a maximum voltage of 1 V because many of the levels of the digitizer would not be used. Instead, in this scenario, a maximum voltage of 0.1 V would provide a better resolution because more the levels of the digitizer are used. Later on, the maximum voltage may be set to 0.4 V, in which case the signal would not be fully recorded if the maximum was 0.1 V, so it would need to be updated prior to the measurement. Further preferably, the operational software of the invention may contain an algorithm for adjusting the voltage range between measurements to ensure that as many levels of the digitizer are used as possible, which therefore improves the voltage resolution.

The trigger system may be triggered by a signal from the photodiode. The sampling oscilloscope may be triggered by the output from one photodiode 107 aligned to a partial reflection of the excitation light pulse from a beam-sampling window, and may record the signal generated by one or more UF-PDs 112. In this way, the sampling oscilloscope (not shown in the figures) is able produces a digital representation of the intrinsic fluorescence lifetime of the proteins in the form of fluorescence decay curves.

Advantageously, the sampling oscilloscope may measure the voltage after a certain period of time has elapsed from receiving the trigger signal, and that period of time increments by ˜50 to ˜150 picoseconds (ps) after every excitation pulse until the full lifetime has been built up over 256 or 512 pulses, for example.

The one or more UF-PDs 112 are configured to detect the fluorescence emission 109 and generate a current proportional to the light intensity, and a connected transimpedance amplifier generates an output voltage (V) signal proportional to the current generated by the photodiode. This voltage signal over time is then recorded, processed, and deconvoluted in order to determine the identity and quantity of the eluted proteins using the deconvolution analysis method described later.

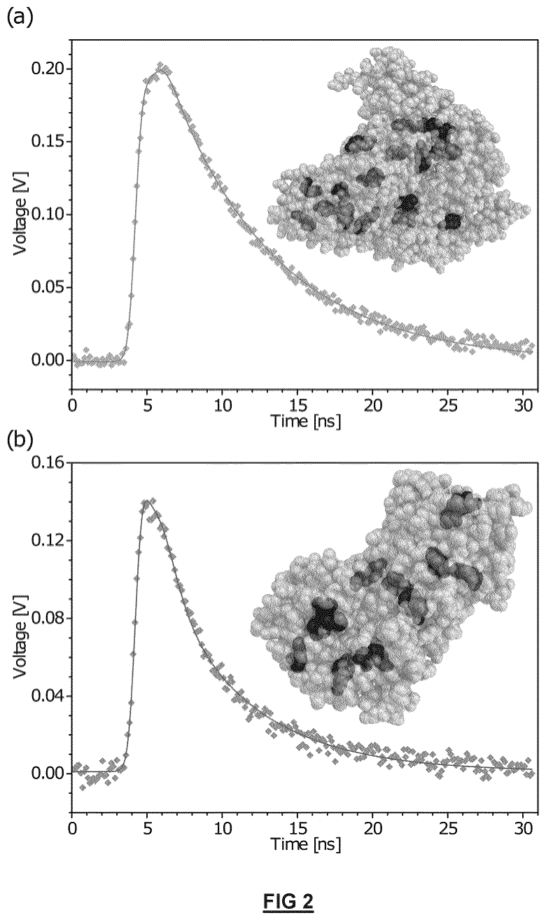

The sampling oscilloscope converts an analogue voltage signal into a digital signal that can be recorded in a data file. Each fluorescence decay curve may be produced and displayed by the sampling oscilloscope using the sampling oscilloscope software. Each fluorescence decay curve may be a digital plot of a series of scatter points as illustrated in FIGS. 2a and 2b. Each scatter point represents the measured output voltage (V) signal as a function of detection time (as measured in ns). In this way, FIGS. 2a and 2b illustrate different fluorescence decay curves for different protein species, where each decay curve comprises a distinct digital voltage (V) signal over time (i.e. as formed by the plotted scatter points) of that protein species. The line represents a retrospective fit to a double decay-component model.

Bovine serum albumin (BSA) and ovalbumin (Ova) are just examples of two distinct protein species that may be co-eluted from the SEC column 111 of the apparatus 100 of the present invention. Co-elution may not occur if the protein species are of different sizes. In this scenario, the inventors instead controlled when the protein species eluted from the column by injecting the proteins at different times such that they eluted with varying degrees of co-elution. A distinct fluorescence decay curve generated for BSA is shown in FIG. 2a, and a distinct fluorescence decay curve for Ova is shown in FIG. 2b. As a reference, the inset diagrams shown in FIGS. 2a and 2b respectively, each show an atomic structures of BSA (PDB: 4F55)[4] and Ova (PDB: 1OVA)[5], where the tryptophan and the tyrosine residues have been shaded within the atomic structure for illustrative purposes. In producing the distinct fluorescence decay curves shown in FIGS. 2a and 2b, BSA and Ova respectively are flowed into a detection volume of the capillary 113 and the data fitting (i.e. the fitted lines) used to evaluate the characteristic decay components and determine their respective contributions is described below.

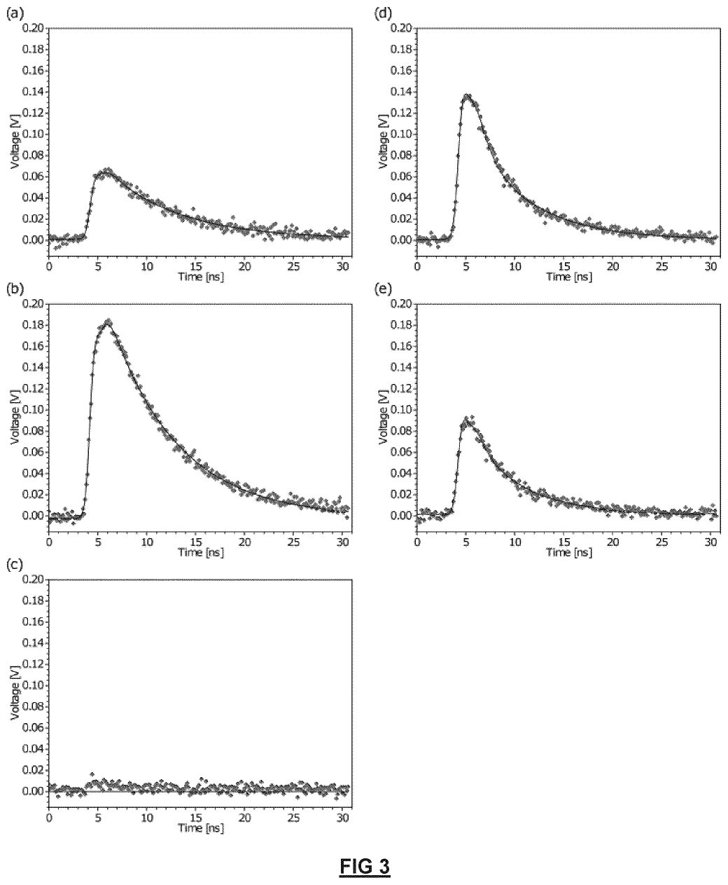

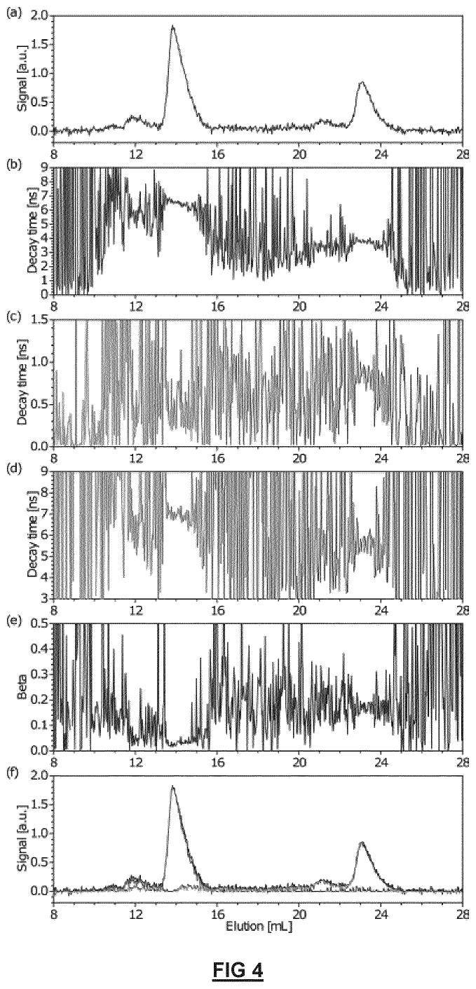

Similarly to the fluorescence decays curves shown in FIGS. 2a and 2b, FIGS. 3a, 3b, 3c, and 3d each illustrate fluorescence decay curves, but for different elution volumes for a BSA and Ova sample in the SEC column 111. FIG. 3a is a fluorescence decay curve for an elution volume of 13.5 mL. FIG. 3b is a fluorescence decay curve for an elution volume of 14.0 mL. FIG. 3c is a fluorescence decay curve for an elution volume of 18.0 mL. FIG. 3d is a fluorescence decay curve for an elution volume of 23.0 mL. FIG. 3e is a fluorescence decay curve for an elution volume of 23.5 mL. During the elution, the decay curves are fitted to a sum of two exponentials model (i.e. the solid line shown in FIGS. 3a, 3b, 3c, 3d and 3e). In order to evaluate the samples, a series of fluorescence time decays are acquired on average every 4.6 s for the data shown in FIGS. 3a, 3b, 3c, 3d and 3e. The fluorescence time decays are then analysed in real-time and retrospectively in order to generate a series of chromatograms, as illustrated in FIG. 4.

Referring to FIG. 4, FIG. 4a illustrates fluorescence time decays when analysed in real-time. FIGS. 4b, 4c, 4d, 4e and 4f illustrate fluorescence time decays when analysed retrospectively. In this way, post-processing of the data yielded the decay chromatograms (DC) shown in FIGS. 4b, 4c, 4d and 4e and the decay-associated chromatogram (DAC) shown in FIG. 4f.

FIG. 4a illustrates a total fluorescence chromatogram (TFC) showing the variation in the total fluorescence intensity, as calculated from the area under each decay curve, as a function of the elution volume. FIGS. 4b, 4c and 4d illustrate decay chromatograms (DCs) showing the variation in the decay times obtained from fits to each decay curve, as a function of the elution volume. The TFC (as shown in FIG. 4a) may be used to monitor the total amount of protein, whereas the DCs (as shown in FIGS. 4b and 4c) may be used to monitor the identity of the proteins by measuring a characteristic that is specific to each protein species. The DCs may be generated by fitting either a double (“DC-2” as shown in FIG. 4c, 4d, 4e) or a single (“DC-1” as shown in FIG. 4b) exponential model to each decay curve. In this way, the fluorescence decay curve may be fitted to a single-exponential or double-exponential model. More than two exponentials could also be envisaged if the complexity of the sample requires it. For example, a fixed third exponential model (e.g. an exponential with a very low amplitude and a very long time decay) may be used such that it effectively acts as a dummy exponential, while two other exponential models obtain fluorescence decay curve information.

The data modelling and/or fitting methods described herein may form part of the methods of the invention described herein. The data modelling and/or fitting methods are preferably performed by a computer program comprising instructions which, when the program is executed by a computer, cause the computer to carry out the data modelling and/or fitting methods. These methods and the other calculations disclosed herein can be performed on a computer system, which may form part of the apparatus of the invention.

The data analysis may be streamlined and automated so that, in the example shown, the TFC is generated in real-time as the proteins are eluted from the SEC column 111. DC-2 shows the first (triangle symbols) and second (square symbols) exponential decay times also known as decay components. The single exponential (DC-1) model may be fitted retrospectively to the decay curves after they had all been recorded, or it may be fitted in real-time. In the experiments carried out in the development of the present invention, the decays times from the 2 decay-component model determined for BSA were found to be 0.520 ns and 7.10 ns, and for Ova were found to be 0.900 ns and 5.66 ns, respectively (and as shown in FIGS. 4c and 4d); the first decay-component contribution from the 2 decay-component model determined for BSA was found to be 0.030, and for Ova was found to be 0.178, respectively (and as shown in FIG. 4e).

The DAC shown in FIG. 4f illustrates the variation in the total fluorescence intensity associated with each individual protein species, as a function of the elution volume. In this example, the DAC is generated by fitting the a double decay-component model similar to the DC-2 to each decay curve, but with the time decays and first decay-component contribution fixed to the characteristic values for BSA and Ova determined previously from a retrospective DC-2 analysis. Two factors of the resulting fitted model are each then proportional to the total fluorescence intensity emitted by one or the other of the two protein species, and so DAC quantifies the elution profile of each protein species. In this example, the DAC is calculated after all of the decays curves had been recorded, but if the characteristic decay times of the proteins species are known in advance, by measuring standard materials for example, then the DAC could be generated in real-time. The resolving power of the apparatus 100 of the present invention may be realised by measuring the TFCs, DCs and DACs (e.g. for BSA and Ova) when they are deliberately co-eluted from the SEC column 111, as is described later.

The mixture may comprise more than one protein, which each have a different intrinsic fluorescence decay signature. In this way, the relative and absolute amount of the two proteins may be determined at one instance in time with no knowledge input as to the amounts of each protein previously or afterwards. Advantageously, the method of the present invention can quantify proteins in a mixture and may not just be limited to chromatography. For example, the DACs may be used for this analysis. In this way, decay parameters/optical signatures of the two proteins may be already known, and each fluorescence lifetime measurement may be curve fitted by summing together two decay curves, each corresponding to the lifetime expected for one or the other of the proteins based on their respective optical signatures. The amount of each decay curve required to accurately fit a particular lifetime curve may determine how much of each protein is present at that time, and this may be plotted in the DAC.

Deconvolution Analysis Algorithms:

In realising the present invention, the inventors devised a deconvolution analysis algorithms of evaluating data recorded by the previously described apparatus 100. In this way, the inventors developed an analytical framework for extracting information from the data regarding the identity and quantity of co-eluting proteins on-the-fly, which does not require the global analysis of an emission decay surface. In this framework, an input to the method may be the pulses of the excitation light 110 (or excitation pulses), and an output is the digitised output voltage (V) signal, as recorded by the sampling oscilloscope.

The physics of the invention may be considered linear so the output signal is the convolution of the input, which in the excitation pulse, and the impulse response, which is the convolution of the impulse responses of the sample 103 and detection electronics. The impulse response of the detection electronics may be determined beforehand, and the impulse response of the sample 103 may contain information on both the quantity and identity of the proteins that have been excited by the excitation light 110. Since convolution is commutative, a digital signal I(t) which may be a digital signal as reported by the sampling oscilloscope, can be modelled using equation (1):

I(t)=∫_{-∞}^{∞}R(t−t′)S(t′)dt′ (1)

Referring to equation (1), R(t) is the convolution of the excitation pulse 110 and the impulse response of the detection electronics, and S(t) is the impulse response of the sample. R(t) may be determined experimentally by measuring the time-profile of the excitation pulse using the same optical setup and detection electronics. As previously discussed, the filter assembly 114 may be positioned before the UF-PDs 112, and may block any excess excitation light 109 from entering the UF-PDs 112. Consequently, this filter assembly may be replaced with a neutral density filter to allow enough light to impinge on the photodiode for the time-profile of the excitation pulse to be measured using the same optical setup and detector electronics. R(t) is modelled by a function consisting of the sum of two Gaussian functions as given in equation (2):

$$R ( t ) = {\sum }_{i = 1}^{2} \frac{{α}_{i}}{{σ}_{i} \sqrt{2 π}} {e}^{\frac{{( t - {φ}_{i} )}^{2}}{2 {σ}_{i}^{2}}} \qquad ( 2 )$$

Where α is the amplitude, σ is the standard deviation, and φ is the temporal offset of the digital representation of the excitation pulse. S(t) is modelled by a function consisting of one exponential decay or a sum of two exponential decays. These models contain one or two decay components, respectively, as given in equation (3):

$$S ( t ) = \{ \begin{matrix}0 & if t < 0 \\ \frac{{β}_{1}}{{τ}_{1}} {e}^{- \frac{t}{{τ}_{1}}} + \frac{{β}_{2}}{{τ}_{2}} {e}^{- \frac{t}{{τ}_{2}}} & if t \geq 0\end{matrix} \} \qquad ( 3 )$$

Where βⱼ where j=1, 2 may be the pre-exponential factor and τⱼ is the fluorescence decay time for each exponential decay component. From equation (1), the digital signal can then be modelled as the following given in equation (4):

$$I ( t ) = \frac{1}{2} {\sum }_{i = 1}^{2} {α}_{i} {\sum }_{j = 1}^{2} \{ \frac{{β}_{j}}{{τ}_{j}} {e}^{\frac{{σ}_{i}^{2} - 2 {τ}_{j} ( t - {φ}_{i} )}{2 {τ}_{j}^{2}}} [ 1 - erf ( \frac{{σ}_{i}^{2} - {τ}_{j} ( t - {φ}_{i} )}{\sqrt{2} {σ}_{i} {τ}_{j}} ) ] \} \qquad ( 4 )$$

If the second pre-exponential factor is set to β₂=0, then S(t) may be modelled with by a function consisting of just one decay component, and the digital signal can then be modelled as the following given in equation (5):

$$I ( t ) = \frac{1}{2} {\sum }_{i = 1}^{2} \frac{{α}_{i} {β}_{1}}{{τ}_{1}} {e}^{\frac{{σ}_{i}^{2} - 2 {τ}_{1} ( t - {φ}_{i} )}{2 {τ}_{1}^{2}}} [ 1 - erf ( \frac{{σ}_{i}^{2} - {τ}_{1} ( t - {φ}_{i} )}{\sqrt{2} {σ}_{i} {τ}_{1}} ) ] \qquad ( 5 )$$

Equivalently Sⱼ(t), the response of the j^{th} protein species, may be modelled as the following given in equation (6):

$${S}_{j} ( t ) = \{ \begin{matrix}0 if t < 0 \\ {γ}_{j} ( \frac{{β}_{j}}{{τ}_{j 1}} {e}^{- \frac{t}{{τ}_{j 1}}} + \frac{1 - {β}_{j}}{{τ}_{j 2}} {e}^{- \frac{t}{{τ}_{j 2}}} ) if t \geq 0\end{matrix} \} \qquad ( 6 )$$

Where

$$β = \frac{{β}_{j 1}}{{β}_{j 1} + {β}_{j 2}}$$

and corresponds to the contribution of the first decay component and γⱼ=βⱼ₁+βⱼ₂ is the sum of the decay components of the j^{th} protein species being addressed by the excitation pulse in the capillary. In this notation, β is a property of the protein species being addressed and γ is proportional to the quantity of that species. When a single exponential decay model is applied, β=1. Each protein species has characteristic τ₁, τ₂ and β that can be used to identify that species as it is eluted from the SEC column 111. Consequently, the digital signal for N proteins species can be modelled as given in equation (7):

$$I ( t ) = {\int }_{0}^{∞} {\sum }_{i = 1}^{2} \frac{{α}_{i}}{{σ}_{i} \sqrt{2 π}} {e}^{- \frac{{( t - {t}^{′} - {φ}_{i} )}^{2}}{2 {σ}_{i}^{2}}} {\sum }_{j = 1}^{N} {γ}_{j} ( \frac{{β}_{j}}{{τ}_{j 1}} {e}^{- \frac{{t}^{′}}{{τ}_{j 1}}} + \frac{1 - {β}_{j}}{{τ}_{j 2}} {e}^{- \frac{{t}^{′}}{{τ}_{j 2}}} ) {dt}^{′} \qquad ( 7 )$$

Since convolution is distributive, this can be solved as follows, as given in equation (8):

$$I ( t ) = \frac{1}{2} {\sum }_{i = 1}^{2} {α}_{i} {\sum }_{j = 1}^{N} {γ}_{j} \{ \frac{{β}_{j}}{{τ}_{j 1}} {e}^{\frac{{σ}_{i}^{2} - 2 {τ}_{j 1} ( t - {φ}_{i} )}{2 {τ}_{j 1}^{2}}} [ 1 - erf ( \frac{{σ}_{i}^{2} - {τ}_{j 1} ( t - {φ}_{i} )}{\sqrt{2} {σ}_{i} {τ}_{j 1}} ) ] + \frac{1 - {β}_{j}}{{τ}_{j 2}} {e}^{\frac{{σ}_{i}^{2} - 2 {τ}_{j 2} ( t - {φ}_{i} )}{2 {τ}_{j 2}^{2}}} [ 1 - erf ( \frac{{σ}_{i}^{2} - {τ}_{j 2} ( t - {φ}_{i} )}{\sqrt{2} {σ}_{i} {τ}_{j 2}} ) ] \} \qquad ( 8 )$$

The fluorescence intensity is the integral of the digital signal plus a baseline offset c which accounts for electrical noise. In a preferred example, the baseline may be calculated by taking the median of the first 13 points in the digital signal, which corresponds to a region of time before the excitation pulse has arrived at the capillary. The fluorescence intensity is calculated by numerically integrating the signal using the trapezoid rule. As the skilled person will appreciate, other numerical integration methods may also work adequately. The contribution of the j^{th} protein species Iⱼ(t) to the fluorescence intensity may be calculated from the fitted parameters by using the following integral equation (9):

Iⱼ(t)=∫_{-∞}^{∞}R(t)*Sⱼ(t)dt=∫_{-∞}^{∞}R(t)dt∫_{-∞}^{∞}Sⱼ(t)dt (9)

Assuming that the time window of the sampling oscilloscope is infinitely wide, then equation (10) is derived:

Iⱼ(t)γⱼΣᵢ₌₁²αᵢ (10)

If the time window of the sampling oscilloscope is infinite, then the contribution of the background I_{background}(t) tends to infinity, since:

I_{background}(t)=∫_{-∞}^{∞}cdt→∞ (11)

If the width of the time window of the sampling oscilloscope is given by θ, then:

Iⱼ(t)=∫₀^{U}R(t)*Sⱼ(t)dt=∫₀^{U}∫_{-∞}^{∞}R(t−t′)S(t′)dt′dt (12)

This can be solved by approximating the shape of the excitation pulse as a delta function,

R(T)˜Σᵢ₌₁²αᵢδ(t−φᵢ) (13)

This assumption is valid because the width of the excitation pulse is much narrower than the width of the time window. The contribution of the j^{th} protein species Iⱼ(t) to the fluorescence intensity measured across the time window is then

$${I}_{j} ( t ) \sim {\sum }_{i = 1}^{2} {α}_{i} {γ}_{j} [ {β}_{j} ( 1 - {s}^{\frac{{φ}_{i} - ∀}{{τ}_{j 1}}} ) + ( 1 - {β}_{j} ) ( 1 - {e}^{\frac{{φ}_{i} - ∀}{{τ}_{j 2}}} ) ] \qquad ( 14 )$$

However, if the size of the time window is chosen such that θ>>τⱼ₁, τⱼ₂, φᵢ, so:

Iⱼ(t)˜γⱼΣᵢ₌₁²αᵢ (15)

The contribution of the background is therefore derived as follows:

I_{background}(t)=cθ (16)

where c is a baseline offset value and θ is a width of the time window of a sampling oscilloscope.

In other words, the fluorescence intensity of the background signal (or noise), I_{background}(t), is the product of a baseline offset c and the time window of a sampling oscilloscope θ, which advantageously accounts for electrical noise of the apparatus and improves the accuracy of the measurements. In a preferred example, the baseline offset c may be empirically determined or calculated by taking the median of the first 13 points in the digital signal, which corresponds to a region of time before the excitation pulse has arrived at the sample or sample capillary.

The above-mentioned mathematical derivations provide deconvolution analysis method for processing the measured signal to identify and quantify the eluted proteins in real time, as is described in the following section. The inventors have therefore advantageously developed algorithms that can fit the data concurrently with data acquisition, enabling real-time product monitoring and pooling decisions (and performing the data analysis thereby may form part of the methods of the invention). The inventors have also developed analytical tools that can quantify individual proteins species as they are eluted from the column, even if they fully co-elute with another protein species, and without making any assumptions about the elution profile. In this way, the method of the present invention advantageously allows for a contribution (or proportion) of each protein of interest to total protein in the mixture to be calculated from the fluorescence decay curve. For example, software has been written that implements curve fitting in real-time as the data was being collected, and the acquisition time of each data point in the chromatogram may be between ˜3 s and ˜6 s, depending on the temporal resolution requested. The software may also be configured to store the data onto a memory (on a computer-readable memory, for example) for off-line analysis or further analysis at a later time.

Deconvolution Analysis Method:

According to another of the invention, there is a method of quantifying the concentration of a protein of interest, or of a conformational state of a protein of interest, in a mixture, wherein the protein of interest or conformational state has an intrinsic fluorescence decay signature.

The method comprises: addressing the mixture with one or more pulses of light, wherein the light has a wavelength in the 240-295 nm range, preferably in the 250-280 nm range, further preferably wherein the laser light has a wavelength of 266 nm.

The method further comprises: taking a series of measurements of the fluorescence intensity of the mixture at a series of time points where the time interval between a fluorescence measurement and the preceding light pulse is recorded.

The series of measurements comprises measurements for which the time intervals differ from each other by less than a nanosecond, and where the difference between largest and smallest time intervals is at least 10 nanoseconds (ns) and/or a sufficient time to detect a decay of the fluorescence intensity towards a baseline level, such that the series of measurements defines a fluorescence decay curve. The method further comprises quantifying the concentration of a protein of interest or of a concentration of the conformational state of the protein of interest in the sample by reference to the fluorescence decay curve. In this way, the method of the present invention is a deconvolution analysis method which utilises the deconvolution analysis algorithms discussed, and derived, in the previous section.

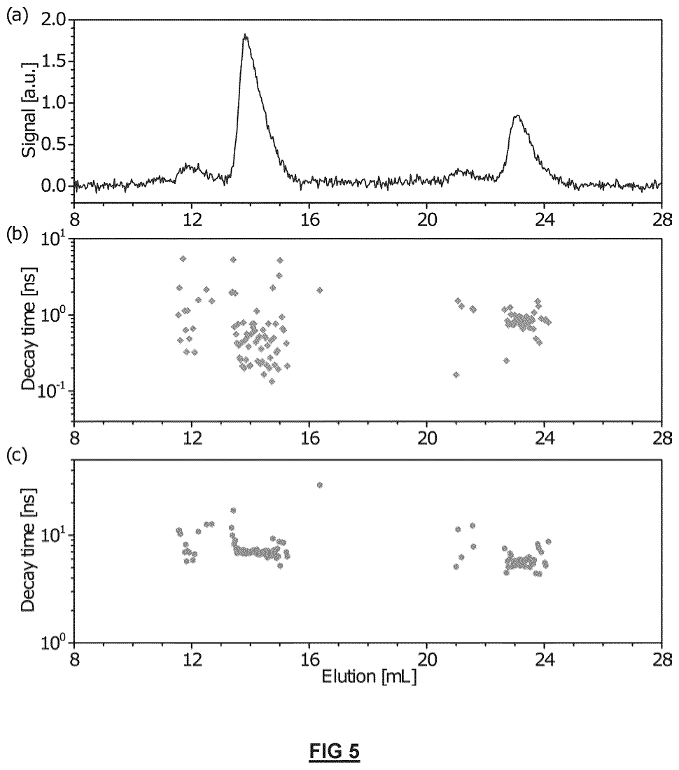

In an example application of the deconvolution analysis method of the present invention, BSA and ovalbumin Ova are different protein species that may be eluted separately from the SEC column 111 of the apparatus 100. A series of fluorescence time decays may then be acquired and analysed in real-time in order to generate a series of chromatograms, as shown in FIG. 5.

FIG. 5 shows real-time TRIF lifetime chromatographs of BSA and Ova separated from the SEC column 111. FIG. 5a shows the TFC which reports the quantity of protein and cannot distinguish between different proteins species. The TFC may be able to identify that there are at least two protein species, at least one corresponding to each peak, but it may not be able to determine which peak is associated with which protein species. FIG. 5b and FIG. 5c shows the decay times of τ₁ and τ₂ respectively from the on-the-fly DC-2 analysis. The decay times are clearly different for each protein species in FIGS. 5b and 5c. In this way, the lead and lag peaks can be identified as BSA and Ova, respectively. Each TFC comprises traces of the measured fluorescence intensity plotted against elution volume. The fluorescence intensity is related to the total quantity of protein being addressed by the excitation pulse 110 and depends on the extinction coefficients and fluorescence yields of the proteins. TFCs are similar to univariate UV-Vis absorption chromatograms. The fluorescence intensity may be calculated as the integral of the digital signal, and the elution volume may be the time elapsed between the acquisition of the measurement and the start of the chromatographic run multiplied by the flow rate.

The DC traces the fluorescence decay times τ₁ and τ₂ against elution volume. The decay times are related to the identity of the protein being addressed by the excitation light pulse 110, and not to the quantity of protein. The DC may be generated by fitting lifetime measurements and plotting the fitted decay times against the elution volume. DC-1s and DC-2s employ models with either one or two decay-components, respectively.

For on-the-fly analysis, DCs are prepared by fitting the lifetime data using either equation (4) or equation (5) depending on whether a DC-2 or DC-1 may be requested and fits are only attempted if there may be sufficient signal. In this example, two decay components are used to fit the data generating DC-2 chromatograms consisting of decay times τ₁ (as shown in FIGS. 5b) and τ₂ (as shown in FIG. 5c) plotted against elution volume.

The deconvolution analysis method may be streamlined and automated so that, in the example shown, the TFC and DC-2 are generated in real-time as the proteins are eluted from the SEC column 111. From inspection of the DC-2, it is clear that BSA and Ova have contrasting fluorescence lifetime profiles which can be used to identify that the leading peak is BSA and the lagging peak is Ova, which could not be determined from inspecting the TFC alone.

The resolving power of the apparatus 100 of the present invention may be evaluated by measuring the eluate when BSA and Ova are deliberately co-eluted from a SEC column 111. The elution volume of each protein species may be controlled by injecting them into the SEC column 111 at different times, with a fixed flow rate of 0.4 ml/min. The inventors subjected the experimental data to analysis offline but there is no technical reason why this same analysis could not also be performed on-the-fly.

As for the on-the-fly analysis, DC-1s and DC-2s are prepared by fitting the lifetime data using either equation (5) or equation (4) but fits are attempted for every lifetime measurement even when there is very low or no measurable signal. For DC-2s the weighting β of the first decay can be plotted against elution volume to generate a first-decay component chromatogram (FDCC).

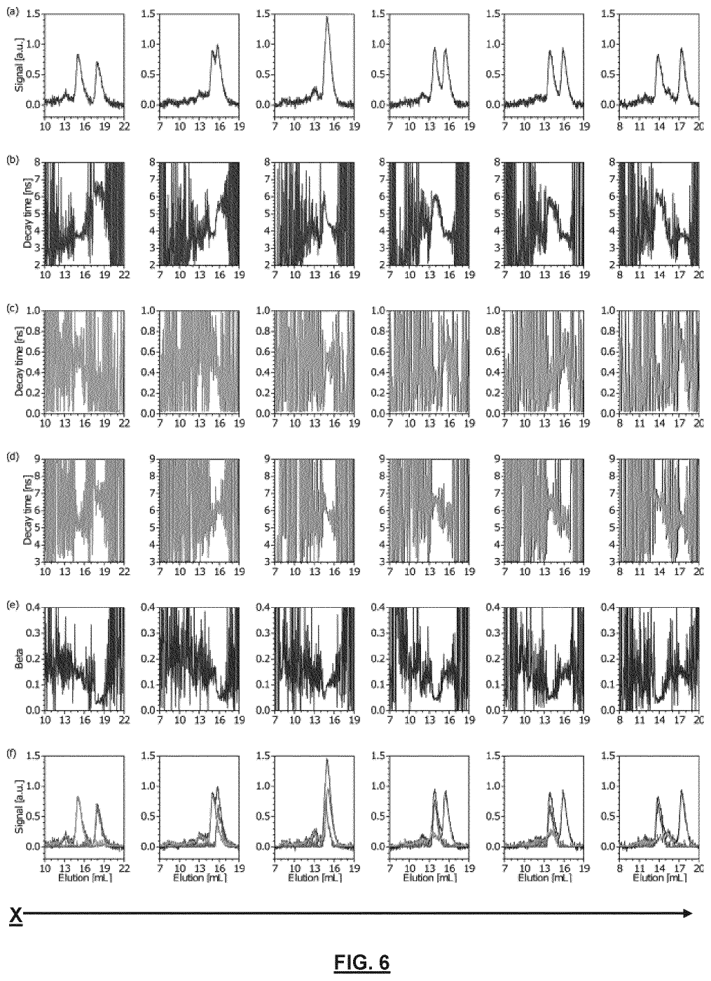

FIG. 6 illustrates the quantification of partially co-eluting proteins species. More specifically, BSA and Ova are separately injected into the SEC column 111 of the assembly 100 at different times to control the degree of overlap of their elution profiles. In this way, the concentrations of the proteins may be quantified by deconvoluting an intrinsic fluorescence decay signature from a first mixture and an intrinsic fluorescence decay signature from a second mixture, wherein the first and the second mixtures may eluate from a column at different elution times.

FIG. 6 illustrates a sequence of chromatograms, including the (a) TFC, (b) DC-1, (c) TAU1, (d) TAU2, (e) FDCC, and (f) DAC for each experiment. Referring to FIG. 6, and moving from left to right along the X-axis (as indicated by the arrow), BSA is injected 4 mL, 2 mL, and 0.8 mL after Ova. Ova is then injected 0.4 mL, 0.8 mL, and 2.4 mL after BSA. The flow rate is 0.4 mL/min. For the DACs, the darker shaded traces represents the TFC minus the background contribution as determined by equation (16), and the lighter shade traces represent the elution profiles of BSA and Ova, respectively.

In one example, BSA is injected 4 ml before Ova and the TFC contains two distinct peaks (as shown in FIG. 6a) which could be identified as BSA or Ova from the accompanying DC-1 trace, which contained two flat traces at the characteristic decay time of each protein species (as shown in FIG. 6b). The DC-1 trace may be flat across the elution volume for each TFC peak, indicating that each peak contained pure protein. The widths of the elution peaks in the TFCs resulted in loss of base-line separation when the volume separating the injection of each protein species may be less than 2.0 ml. The DC-1 traces transitioned between the two characteristics decay constants, appearing sloped, where the TFC peaks partially overlapped, indicating that mixtures of the two proteins are being eluted. The DC-1 traces converged to flat lines when the peaks ceased to overlap, demonstrating that the DC-1 traces can be used to assess protein purity.

Referring to FIG. 6, when BSA is injected 0.8 ml before Ova, the two protein species co-eluted almost exactly, such that only a single peak is observed in the TFC. The DC-1 trace contained a sharp change in the decay time, which indicated that the single TFC peak did not contain a single, pure protein species, and that it contained at least two poorly resolved proteins.

The goodness-of-the-fit to lifetime measurements is typically improved by using a two decay-component model instead of a single decay-component model, so the combination of the fluorescence decay times τ₁ and τ₂ (as shown in FIG. 6c and FIG. 6d respectively) alongside the weighting β of the first decay component (as shown in FIG. 6e) can be used to characterise the time-profile of the intrinsic fluorescence of different protein species. The parameters τ₁, τ₂, and β can be used to uniquely characterise different proteins species as they are dependent only on the optical properties of the aromatic residues of the proteins in their environment only. This can be utilised to construct the DACs which trace the contribution of each of j protein species to the TFC. DACs require prior information on the τⱼ₁, τⱼ₂ and βⱼ parameters for each of the j protein species eluted from the chromatographic column but do not make any assumptions about the elution profile of each species. DACs are prepared by fitting the lifetime measurements with equation (8) with β, τⱼ₁ and τⱼ₂ fixed and the parameters γⱼ free to vary. The contribution of the j^{th} protein species could then be calculated using equation (14), which is then plotted against elution volume (as shown in FIG. 6f).

For example, the data set from the experiment shown in FIG. 5 may be re-analysed to determine the τ₁, τ₂ and β parameters for BSA and Ova since there is no overlap in their elution profiles in this run.

The parameters used for the DAC analysis are the fit parameters for the decay measurements closest to the peak positions in the TFC, which are determined by fitting the TFC using an exponentially modified Gaussian function. For BSA: τ1=0.520327 ns, τ2=7.10122 ns, and β3=0.03012; and for Ova: τ1=0.900353 ns, τ2=5.65585 ns, and β=0.17753. The DAC shows the variation in the total fluorescence intensity associated with each individual protein species, as a function of the elution volume (as shown in FIG. 6f). In this example, the DAC is calculated after all of the decays curves had been recorded, but if the characteristic parameters of the proteins species are known in advance, by measuring standard materials for example, then the DAC could be generated in real-time.

In this way, the method may optionally use 256 or 512 pulses to build-up a measurement of the fluorescence lifetime and provides an accurate readout of the fluorescence intensity.

The present invention has numerous advantages over known analytical methods which use frequency-domain measurements, which is the most common strategy employed in PAH detection, for example. To illustrate, frequency-domain measurements require continuous-wave, instead of pulsed excitation sources, and therefore either require significantly more sensitive detectors, or require much higher excitation powers for signal recovery. Moreover, these known methods are also required to be optically and electronically isolated from the environment to eliminate DC noise sources and contributions from common electrically frequencies such as 50 Hz, and the modulation of the excitation source would have needed to be purely sinusoidal to prevent the generation of harmonics. In this way, the present invention realises many advantages over known detection methods.

The DAC trace, which represents the amplitudes for each decay in the signal, is able to resolve the two proteins regardless of whether there is full, partial or no overlap between the TFC peaks, providing in fine detail, the elution profile of each protein species that contributed to the overall elution profile shown in the TFC.

There are secondary peaks in the elution profiles of both individual protein preparations, which are most likely non-covalently formed dimers. These species could be monitored accurately with DAC but not by DC or TFC. For instance, when Ova is injected 0.8 ml after BSA, the DAC trace shows that the secondary peak of Ova fully co-elutes with BSA (FIG. 6f, column 5), whereas this could not be deduced from the TFC or DC traces.

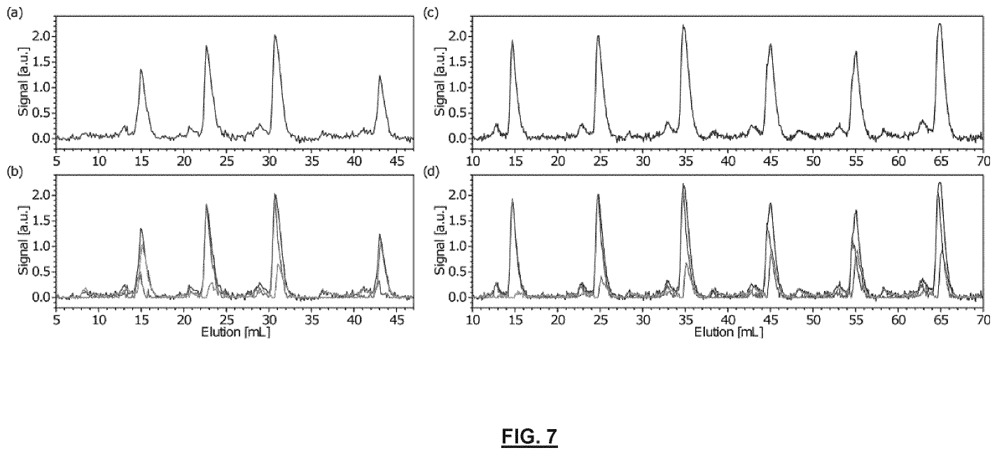

The inventors tested whether DACs could accurately determine the concentration of each co-eluting protein species by injecting different concentrations of BSA and Ova into the apparatus 100 such that they always fully co-eluted from the SEC column 111. FIG. 7 illustrates a quantification of co-eluting protein species. In two experiments, a series of BSA and Ova samples at different concentrations are injected into the SEC column 111 such that the BSA and Ova elution profiles are fully overlapping.

Referring to FIG. 7, the TFCs of the (a) first and (c) second experiment, the separate elution profiles are indistinguishable, but in the DACs (b) and (d) traces for BSA and Ova can be deconvoluted. Moving from left to right along the X-axis (as indicated by the arrow), the BSA concentrations are 1 mg/mL, 5 mg/mL, 5 mg/mL and 0.5 mg/mL, and the Ova concentrations are 5 mg/mL, 1 mg/mL, 3 mg/mL and 5 mg/mL. For the second experiment, the BSA concentrations are 5 mg/mL, 5 mg/mL, 5 mg/mL, 4 mg/mL, 3 mg/mL and 5 mg/mL, and the Ova concentrations are 0.5 mg/mL, 2 mg/mL, 4 mg/mL, 5 mg/mL, 5 mg/mL and 5 mg/mL.

For each set of injections, only a single primary peak is visible in the TFC (as shown in FIG. 7a and FIG. 7c) but the elution of each protein species could be tracked in the accompanying DAC (as shown in FIG. 7b and FIG. 7d). Since the DAC traces deconvolves the TFC into separate elution profiles for each protein species without making assumptions about the elution profile, it is possible to fit the DACs using a peak shape function to quantity each protein species. The DAC peaks may be fitted using an exponentially modified Gaussian function.

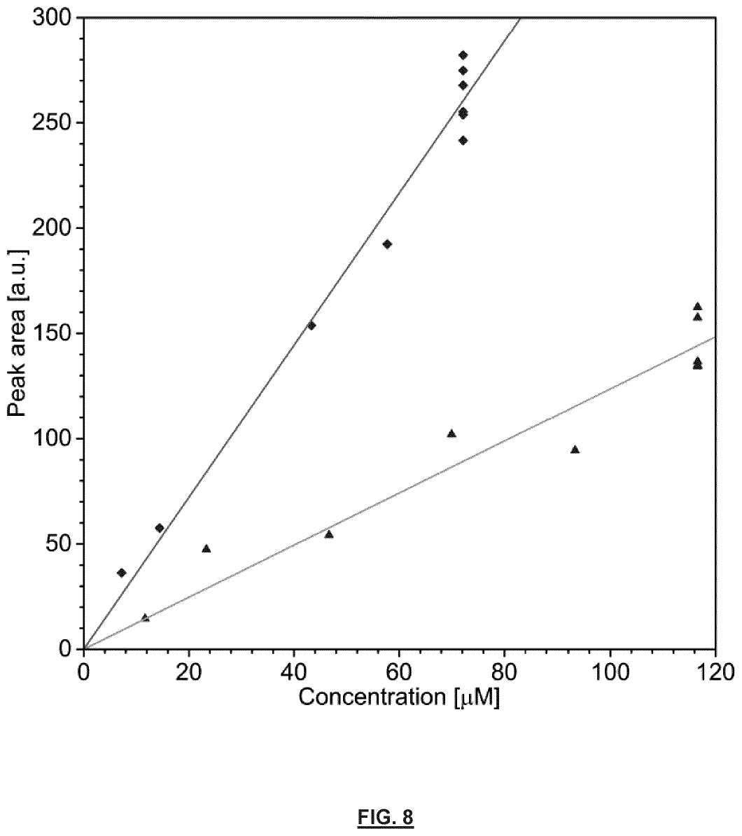

FIG. 8 illustrates a graph of peak areas (as measured in arbitrary units a.u.) plotted against protein concentration (as measured in μM). More specifically, the area under each of the primary peaks for the DAC traces for BSA (diamond-shaped scatter points) and Ova (triangle-shaped scatter points) in FIG. 7 have been plotted against the known concentration of the injected sample 103 in the SEC column 111. Referring to FIG. 8, the linear fits for the BSA (dark line) and Ova (light line) to the different scatter plots illustrate how the peak area is linearly proportional to the concentration of each protein species.

The quantity of each proteins species is proportional to the area under the peak, which varies linearly with the protein concentration injected (as shown in FIG. 8). The gradient depended on the number of aromatic residues per protein and their quantum yield with pumping at 266 nm. In this way, the quantification of the concentration of the protein of interest or of a concentration of the conformational state of the protein of interest may comprise calculating the area under the deconvoluted portion of the fluorescence decay curve that corresponds to the intrinsic fluorescence decay signature.

In this way, the method of the present invention advantageously allows the absolute quantity of the protein of interest to be estimated as the area under the curve may be proportional to the concentration. The fluorescence intensity may be calculated from determining the area under the fluorescence lifetime curve, and this correlates with the amount of protein. The identity of the proteins may be determined from the fluorescence lifetime characteristics. In short, the fluorescence lifetime data may be fitted to a model which has three parameters that are characteristic to the protein. These three parameters may therefore be an optical signature for the protein.

In one embodiment, a time period of each of the multiple calculations may be less than 10 seconds. In another example embodiment, the instrument may collect a series of fluorescence lifetime measurements every 4 to 5 second, but this then needs to be interpreted to generate chromatograms for the individual proteins.

The concentration of more than one protein may be quantified. In this way, the method of the present invention is advantageously applicable to protein solutions comprising multiple different varieties, or types, of proteins. The method is also advantageously applicable to at a wide range of protein concentrations which ensures that it may be relevant to the fields of bioprocessing or food industry research, for example.

The concentrations of the proteins may be quantified by deconvoluting more than one intrinsic fluorescence decay signature from a single fluorescence decay curve. The method of the present invention may not be limited to analysing two protein species. For example, two optical signatures may be input, but more than two protein species may be identified. A lifetime measurement of an ensemble of different proteins may be acquired and the data can be fitted as though there may only be one additional protein species present in the sample along with the target protein of interest (e.g. in the sample of interest 103). For example, the method may be able to attribute an optical signature to the cell lysate, and then generate DACs as previously described, possibly without the chromatography column, except that one curve may be the cell lysate and the other may be the protein of interest.

Ideally, the excitation pulse would be as short as possible because this is a time-resolved measurement. However, the inventors have devised a method which advantageously provides a trade-off between the energy of the pulse, its pulse length, and the cost of the laser system. For example, using a nanosecond pulsed laser may affect the data analysis as the pulse length (e.g. in the region of ˜1 ns) may be longer than a typical first decay components (e.g. in the region of 0.4 ns to 0.9 ns), and not much shorter than a typical second decay component (e.g. in the region of 2 ns to 7 ns). Consequently, the output may be a convolution of the time profile of the excitation pulse, the fluorescence lifetime of the sample, and the instrument response of the detector electronics. This impacts the data analysis because the data has to be fitted to a different model. It also affects the apparatus design because a mechanism for measuring the impulse response of the system has to be devised. In this way, the inventors have designed the apparatus configuration to make it possible to detect very subtle differences between the proteins. In general, the more accurately the lifetime measurements can be acquired, the more accurately the optical signatures can be initially determined, and the more accurately the amount of each protein at a given time can be calculated.

In one embodiment, the intrinsic fluorescence decay signature of the protein of interest may be determined by addressing a sample of interest 103, comprising the protein of interest and essentially no other proteins, with a laser pulse 110 (or excitation pulse 110) as described previously, and taking the series of measurements of the fluorescence intensity of the sample of interest 103 as described previously.

In another embodiment, the deconvolution of the fluorescence decay curve comprises statistical modelling of the fluorescence decay curve for quantifying two, or more than two co-eluting proteins. Advantageously, the method of the present invention can quantify more than two co-eluting proteins enabled by simultaneous measurement of both the time decay and the fluorescence intensity.

### Example Application (Experimental Method)

FIG. 6 illustrates an example experimental application of the previously described apparatus 100 of the present invention when used in combination with the previously described deconvolution analysis, and when applied to two co-eluting protein species, namely BSA and Ova. Sample preparation of the sample of interest 103 includes dissolving BSA and Ova (as supplied by Sigma Aldrich UK) into one or more buffer solutions. Each buffer solution may be prepared by dissolving buffer salts (as supplied by Sigma Aldrich UK) in ultrapure water (>18 MΩ·cm). The one or more buffer solutions were degassed by helium sparging (as supplied by BOC group) and filtered by 0.22 μm “Stericup” vacuum filtration units (as supplied by Merck & Co).

In an example embodiment, LabVIEW 2015 (as produced by National Instruments™) may be used to control the experimental equipment (e.g. the sampling oscilloscope or the high-bandwidth digitizer) and provide real-time analysis of the variations in fluorescence intensity and lifetime. For each experiment, a new fluorescence intensity and lifetime measurement would begin as soon as the previous measurement finished as the sample is continuously eluted from the chromatographic column. For example, the width of the elution peak is typically much wider than the ˜33 μL eluted between measurements. Each lifetime measurement is tagged with a record of the time that the measurement is taken.

In the present invention, the elution volume of each protein species is controlled by injecting them into the column at different times, with a fixed flow rate of 0.4 ml/min. In one example, BSA is injected 4 ml before Ova, and the TFC contained two distinct peaks which could be identified as BSA or Ova from the accompanying DC trace, which contained two flat traces at the characteristic decay time of each protein species. The DC trace is flat across the elution volume for each TFC peak, indicating that each peak contained a highly pure protein.

The widths of the elution peaks in the TFCs result in loss of base-line separation when the volume separating the injection of each protein species is less than 2.0 ml. The DC traces transitioned between the two characteristics decay constants, appearing sloped, where the TFC peaks partially overlapped, indicating that mixtures of the two proteins are being eluted.

The DC traces converged to flat lines when the peaks ceased to overlap, demonstrating that the DC traces can be used to assess protein purity.

The inventors found that when BSA is injected 0.8 ml before Ova, the two protein species co-eluted almost exactly, such that only a single peak is observed in the TFC. The DC trace contained a sharp change in the decay time, which indicated that the single TFC peak did not contain a single, pure protein species, and that it contained at least two poorly resolved proteins. The DAC trace, which represents the amplitudes for each decay in the signal, is able to resolve the two proteins regardless of whether there is full, partial or no overlap between the TFC peaks, providing in fine detail, the elution profile of each protein species that contributed to the overall elution profile shown in the TFC.

There are secondary peaks in the elution profiles of both individual protein preparations, which are most likely non-covalently formed dimers as they are indistinguishable from the monomer peak by mass spectrometry. These species may be monitored accurately with DAC but not by DC or TFC. For instance, when Ova is injected 0.8 ml after BSA, the DAC trace shows that the secondary peak of Ova fully co-elutes with BSA (e.g. the 5^{th} column in the sequence of graphs shown in FIG. 6), whereas this may not be deduced from the TFC or DC traces.

In devising the apparatus 100 of the present application, the inventors tested whether DACs may accurately determine the concentration of each co-eluting protein species by injecting different concentrations of BSA and Ova into the chromatograph, such that they always fully co-eluted from the SEC column 111.

As such, TRIF of the apparatus 100 and method of the present invention can be used to monitor the elution of multiple different species proteins during chromatography. Additionally, by generating decay-associated chromatograms (DACs) in real-time, the elution profile of two different protein species can be monitored independently, even when they fully or partially co-elute. This overcomes a major shortcoming of chromatograms measured by UV-absorption or intrinsic fluorescence intensity, as these can only monitor the total amount of protein eluted. Whilst the capital cost of a TRF chromatogram is often greater than that of a conventional UV-absorption chromatogram due to the UV laser and the high bandwidth electronics, the cost of operation is comparable. TRF-based chromatography is well placed to be used as a process analytical technology for monitoring the product concentration in continuous manufacturing processes, or for making accurate peak-cutting and fraction pooling decisions in batch purification processes. In this way, the concentration of the protein of interest or the concentration of a conformational state of the protein of interest may be calculated multiple times, to determine a change in the concentration of the protein of interest over time and/or to determine the concentration of the protein of interest in more than one eluate fraction.

Computer Systems

The systems and methods of the above embodiments may be implemented in a computer system (in particular in computer hardware or in computer software) in addition to the structural components and user interactions described.

The term “computer system” includes the hardware, software and data storage devices for embodying a system or carrying out a method according to the above described embodiments. For example, a computer system may comprise a central processing unit (CPU), input means, output means and data storage. Preferably the computer system has a monitor to provide a visual output display (for example in the design of the business process). The data storage may comprise RAM, disk drives or other computer readable media. The computer system may include a plurality of computing devices connected by a network and able to communicate with each other over that network.

The methods of the above embodiments may be provided as computer programs or as computer program products or computer readable media carrying a computer program which is arranged, when run on a computer, to perform the method(s) described above.

The term “computer readable media” includes, without limitation, any non-transitory medium or media which can be read and accessed directly by a computer or computer system. The media can include, but are not limited to, magnetic storage media such as floppy discs, hard disc storage media and magnetic tape; optical storage media such as optical discs or CD-ROMs; electrical storage media such as memory, including RAM, ROM and flash memory; and hybrids and combinations of the above such as magnetic/optical storage media.

The methods of the above embodiments may be provided as computer programs or as computer program products or computer readable media carrying a computer program which is arranged, when run on a computer, to perform the method(s) described above.

The term “computer readable media” includes, without limitation, any non-transitory medium or media which can be read and accessed directly by a computer or computer system. The media can include, but are not limited to, magnetic storage media such as floppy discs, hard disc storage media and magnetic tape; optical storage media such as optical discs or CD-ROMs; electrical storage media such as memory, including RAM, ROM and flash memory; and hybrids and combinations of the above such as magnetic/optical storage media.

### REFERENCES

A number of publications are cited above in order to more fully describe and disclose the invention and the state of the art to which the invention pertains. Full citations for these references are provided below. The entirety of each of these references is incorporated herein.
For standard molecular biology techniques, see Sambrook, J., Russel, D. W. Molecular Cloning, A Laboratory Manual. 3 ed. 2001, Cold Spring Harbor, N.Y.: Cold Spring Harbor Laboratory Press.
[1]. Hahn, T.; Huuk, T.; Osberghaus, A.; Doninger, K.; Nath, S.; Hepbildikler, S.; Heuveline, V.; Hubbuch, J. Calibration-free inverse modeling of ion-exchange chromatography in industrial antibody purification. Eng. Life Sci. 2016, 16, 107-113.
[2]. Hahn, T.; Baumann, P.; Huuk, T.; Heuveline, V.; Hubbuch, J. UV absorption-based inverse modeling of protein chromatography. Eng. Life Sci. 2016, 16, 99-106.
[3] Field N, et al; High-throughput investigation of single and binary protein adsorption isotherms in anion exchange chromatography employing multivariate analysis, 2017 JOURNAL OF CHROMATOGRAPHY A Volume: 1510, Pages: 13-24, DOI: 10.1016/j.chroma.2017.06.012
[4]. Bujacz, A. Structures of bovine, equine and leporine serum albumin. Acta Crystallogr. D Struct. Biol. 2012, 68, 1278-1289.
[5]. Stein, P. E.; Leslie, A. G. W.; Finch, J. T.; Carrell, R. W. Crystal structure of uncleaved ovalbumin at 1.95 Å resolution. J. Mol. Biol. 1991, 221, 941-959.

1. A method of quantifying the concentration of a protein of interest, or the concentration of a conformational state of the protein of interest, in a mixture, wherein the protein of interest or conformational state has an intrinsic fluorescence decay signature, the method comprising:
addressing the mixture with one or more pulses of light, wherein the light has a wavelength in the 240-295 nm range, preferably in the 250-280 nm range, further preferably wherein the light has a wavelength of 266 nm,
taking a series of measurements of the fluorescence intensity of the mixture at a series of time points; wherein the time interval between a fluorescence measurement and a preceding light pulse is recorded and wherein the series of measurements comprises measurements for which the time intervals differ from each other by less than a nanosecond; and wherein the difference between largest and smallest time intervals is at least 10 ns and/or a sufficient time to detect a decay of the fluorescence intensity towards a baseline level, such that the series of measurements defines a fluorescence decay curve, and
quantifying the concentration of the protein of interest or of the conformational state of the protein of interest in the sample by reference to the fluorescence decay curve.

2. The method according to claim 1, wherein the quantification of the concentration of the protein of interest or the concentration of the conformational state of the protein of interest comprises deconvoluting the fluorescence decay curve to quantify the contribution of the intrinsic fluorescence decay signature from different proteins species or conformational states of the protein species to the fluorescence decay curve.

3. The method according to claim 2, wherein the quantification of the concentration of the protein of interest or the concentration of the conformational state of the protein of interest comprises calculating the area under the deconvoluted portion of the fluorescence decay curve that corresponds to the intrinsic fluorescence decay signature of the protein of interest or of a conformational state of the protein of interest.

4. The method according to any one of the preceding claims, wherein the mixture is a portion of an eluate from a chromatography column.

5. The method according to any one of the preceding claims, wherein the mixture comprises more than one protein, which each have a different intrinsic fluorescence decay signature.

6. The method according to any one of the preceding claims, wherein the fluorescence decay curve is measured multiple times, to allow a change in the concentration of the protein of interest over time and/or to determine the concentration of the protein of interest in more than one eluate fraction to be determined.

7. The method according to claim 6, wherein a time period between two fluorescence decay curve measurements is less than 10 seconds.

8. The method according to any one claim 5 to claim 7, wherein the concentration of more than one protein is quantified.

9. The method according claim 8, wherein the concentrations of the proteins are quantified by deconvoluting more than one intrinsic fluorescence decay signature from a single fluorescence decay curve.

10. The method according claim 9, wherein the concentrations of the proteins are quantified by deconvoluting a first intrinsic fluorescence decay signature from a first mixture and a second intrinsic fluorescence decay signature from a second mixture, wherein the first and the second mixtures are eluate from a column at different elution times.

11. The method according claim 9, wherein the concentrations of the proteins are quantified by deconvoluting a first intrinsic fluorescence decay signature and a second intrinsic fluorescence decay signature from a single mixture.

12. The method according to any one of the preceding claims, wherein the one or more pulses of light have a pulse width is less than 10 ns, preferably less than 5 ns, further preferably less than 2 ns.

13. The method according to any one of the preceding claims, wherein the fluorescence decay curve is fitted to a single-exponential or double-exponential model.

14. The method according to any one of the preceding claims, wherein the intrinsic fluorescence decay signature of the protein of interest has been determined by addressing a sample comprising the protein of interest and essentially no other proteins with the one or more pulses of light as defined by claim 1 and taking the series of measurements of the fluorescence intensity of the sample as defined by claim 1.

15. The method according to any of claim 2 to claim 14; wherein deconvoluting the fluorescence decay curve comprises statistical modelling of the fluorescence decay curve for quantifying more than two co-eluting proteins.

16. The method according to any preceding claim; wherein contribution of a background noise signal, I_{background(t)}, is calculated using the following equation:
I_{background}(t)=cθ
where c is a baseline offset value and θ is a width of the time window of a high-bandwidth digitizer or a sampling oscilloscope.

17. The method according to any preceding claim; wherein the method further comprises a generation of one or more decay chromatograms, DCs, by fitting a double, DC-2, exponential model to the fluorescence decay curve.

18. The method according to any preceding claim; wherein the method further comprises a generation of one or more decay-associated chromatograms, DACs, by fitting equation (8) to the fluorescence decay curve, and calculating the contribution of each proteins species to the fluorescence intensity measured across the time window using equation (14).

19. The method according to any preceding claim; wherein the method further comprises quantifying two co-eluting proteins by simultaneous measurement of both a time decay and the fluorescence intensity.

20. The method according to any preceding claim; wherein each protein species has a characteristic τ1, τ2 and β that can be used to identify that species, where in a sum of two exponential decays model, τ1 and τ2 are the first and second fluorescence decay times and β is the contribution of the first decay component.

21. Apparatus for measuring the concentration of a protein of interest in a mixture of proteins, comprising:
a light source capable of addressing the mixture with pulses of light at a wavelength in the range 240-290 nm, preferably in the range 250-280 nm, further preferably at a wavelength of 266 nm,
one or more detectors responsive to light at wavelengths between 300 nm and 400 nm and configured to measure the fluorescence intensity of the mixture; said one or more detectors being capable of taking a series of measurements, each measurement spanning a sub-nanosecond time interval, and
a trigger system capable of initiating the first measurement before the signal from the fluorescence measurements arrives at a digitizer.

22. The apparatus according to claim 21; wherein the light source is a single light emitting diode, an array of light emitting diodes, and/or a laser.

23. The apparatus according to claim 22; wherein the laser is a diode pumped Q-switched solid state laser.

24. The apparatus according to any one of claims 21 to 23; wherein the fluorescent emission is reflected towards the one or more detectors by a reflector or a lens.

25. The apparatus according to claim 24; wherein the reflector is an ellipsoidal reflector.

26. The apparatus according to claim 24 or claim 25; wherein the fluorescent emission is reflected towards the one or more detectors via a filter assembly.

27. The apparatus according to claim 26; wherein the fluorescent emission is reflected towards the one or more detectors via a long-pass optical filter.

28. The apparatus according to any one of claims 21 to 27; wherein the apparatus comprises a beam splitter configured to split the emitted pulses of laser light into first and second portions, where the first portion is directed to a photodiode and the second portion is directed towards the protein of interest in the mixture of proteins.

29. The apparatus according to claim 28, wherein the trigger system is triggered by a signal from the photodiode.

30. The apparatus according to any one of claims 21 to 23; wherein the one or more detectors are one or more photodiodes with a sub-nanosecond rise time.

31. The apparatus according to claim 30; wherein the one or more ultra-fast photodiodes is connected to a high bandwidth transimpedance amplifier.

32. A liquid flow system comprising the apparatus according to any one of claims 21-31 and a chromatography assembly, wherein said apparatus is assembled such that the mixture that is addressed by the light is eluate in an elution capillary of the chromatography assembly.

33. The liquid flow system according to claim 32, wherein the elution capillary is a straight capillary.
